(19) United States
(12) Patent Application Publication
(10) Pub. No.: US 2012/0156668 A1
(43) Pub. Date: Jun. 21, 2012

(54) EDUCATIONAL GAMING SYSTEM

(75) Inventor: Michael Gregory Zelin, Fayetteville, AR (US)

(73) Assignee: Mr. Michael Gregory Zelin, Fayetteville, AR (US)

(21) Appl. No.: 13/291,362

(22) Filed: Dec. 9, 2011

Related U.S. Application Data
(60) Provisional application No. 61/459,802, filed on Dec. 20, 2010.

(51) Int. Cl. G09B 7/00

(52) U.S. Cl. 434/362

(57) ABSTRACT

Educational gaming systems and methods provide an active learning environment to multiple users, wherein various incentives are provided to the users for enhanced engagement in learning, such as, for example, but not limited to, novel reward mechanisms, serious game elements, user collaboration, social interaction and the like.

This application claims benefits and the priority of the provisional patent 61/459802 filed Dec. 20, 2010.

### BACKGROUND OF THE INVENTION

1. Field of the Invention

Embodiments of the present invention generally relate to education systems, and more particularly, to, systems and methods for multimedia based learning in a computer-based environment.

2. Discussion of the Related Art

It is a well known fact, that Internet has become a valuable tool for learning. Through the use of the Internet, multiple users can access new information, points of view and experiences that they would otherwise not have been able to encounter. There are several Internet tools that prove particularly useful to users for learning as these tools make it easier for users to enhance their learning by readily providing access to information that would have been hard to acquire in the past.

An efficient educational system should focus on both sides of the educational process, i.e. teaching and learning. However, existing computer based educational solutions predominantly focus on one side of the process. Till now, educational systems have been primarily focusing on increased efficiency of teaching by implementing modern technology, including both personal computer, and the Internet-based innovations. For example, computer based educational systems by Breig US patent application number 20090142737, 2009 teaches a System and Method for Developing Reading Skills by presenting multimedia content including a text-based passage, animated text, audio and graphic aids to a reader, and able to receive input from the reader.

Similarly, US patent application number 20090204880, 2009 teaches a Method of Story Telling Presentation and Manufacturing Multimedia File Using Computer, and Computer Input Device and Computer System for the Same by Ko enables users to create multimedia compositions by creating and embedding images in presentations.

However, while these and other similar computer based systems provide educational programs, their main limitation is related to the lack of user interaction with other users and limited educational resources that can be provided to the user.

On-line based educational systems eliminate these limitations. Numerous educational systems have been developed for creating and hosting on-line educational content. The following are examples of existing solutions developed primarily for individual users-learners: Hudgeons et al. US patent application number 20100169907 teaches a method and system for facilitating interactive multimedia experiences enabling facilitation of audience response tracking, experience navigation and feedback of audience responses. For example, Mears US patent application number 20100261148 teaches a system and method for educating using multimedia interface facilitating interest in the arts and facilitating preparation of a portfolio of creative work in the form of a digital resume.

Currently, a number of systems have also been developed for organizations, such as virtual schools. For example, Packard et al. US patent application number 20070196807 discloses a System and Method of Virtual Schooling for learning various subjects, including, History/Civics/Geography, Language Arts, Math, Music, Science, and Visual Arts, with lessons integrating on-line and off-line instructional materials. However, these systems primarily provide proprietary teaching materials predominantly in a form of approved curriculum courses, lessons, or tutorials developed by experts for students' studies. While they provide teaching materials and teaching services enabling students to receive formal education and corresponding class credits, their main disadvantages are related to use of a standard teaching structure with limited student engagement in active learning and limited educational materials resource database.

On-line educational systems relying on non-formal educational material sources provide a significantly larger base for teaching resources development. To motivate users to develop and post their educational materials, some systems share with authors revenues from advertisements posted on users' pages. For example, Lax et al. US patent application number 20090006375 disclose Methods, Systems, and Apparatus for Selection of Advertisements for Placement with Content. Important benefits of these systems include flexibility, i.e. they can be related to different subjects and simplicity of use. Still, their major limitation is that they focus on creation of teaching tutorials. Moreover, they utilize the standard teaching approach, wherein users, experts in different fields, create materials, which can be studied by learners. However, the learner's engagement in learning process is limited to studying of these on-line tutorials.

Moreover, educational computer games enhance involvement in learning and improve learning outcomes. For example, Delbue US patent application number 20090325136 teaches Computer-implemented environments and interfaces for educational games allowing a player at a first remote computer to play one or more educational games at the first remote computer and allowing a thematic specialist at a second remote computer to modify content or rules of the one or more educational games. However, the limitations of Delbue's invention are related to a narrow scope limited to a specific subject or topic, and appeal to a certain age group. Further, it is expensive to develop.

Therefore, there exists a need in the art for educational gaming systems and methods, which eliminates the disadvantages of on-line educational systems and on-line educational games, as discussed hereinabove.

### BRIEF DESCRIPTION OF THE FIGURES

So that the features of the present invention can be understood in detail, a more particular description of the invention with a reference to embodiments, some of which are illustrated in the appended drawings, is provided. It is to be noted, however, that the appended drawings illustrate only typical embodiments of this invention and are therefore not to be considered limiting of its scope, for the invention may admit to other equally effective embodiments.

The features, benefits and advantages of the present invention will become apparent by reference to the following text figures, with like reference numbers referring to like structures across the views, wherein:

FIG. 1 illustrates a system 100 for multimedia based learning in a computer-based environment, according to one embodiment of the present invention;

FIG. 2A illustrates a Content Management Module of the system 100 for multimedia based learning in a computer-based environment, according to one embodiment of the present invention;

FIG. 2B illustrates a User Management Module of the system 100 for multimedia based learning in a computer-based environment, according to one embodiment of the present invention;

FIG. 2C illustrates a collaboration Management Module of the system 100 for multimedia based learning in a computer-based environment, according to one embodiment of the present invention;

FIG. 2D illustrates a Social Interaction Management Module of the system 100 for multimedia based learning in a computer-based environment, according to one embodiment of the present invention;

FIG. 2E illustrates a Reward Module of the system 100 for multimedia based learning in a computer-based environment, according to one embodiment of the present invention;

FIG. 2F illustrates a Commerce Module of the system 100 for multimedia based learning in a computer-based environment, according to one embodiment of the present invention;

FIG. 2G illustrates a Gaming Module of the system 100 for multimedia based learning in a computer-based environment, according to one embodiment of the present invention;

FIG. 2H illustrates a Customization Module of the system 100 for multimedia based learning in a computer-based environment, according to one embodiment of the present invention;

FIG. 2I illustrates a Process Module of the system 100 for multimedia based learning in a computer-based environment, according to one embodiment of the present invention;

FIG. 2J illustrates a Simulation Module of the system 100 for multimedia based learning in a computer-based environment, according to one embodiment of the present invention;

FIG. 2K illustrates a Control Module of the system 100 for multimedia based learning in a computer-based environment, according to one embodiment of the present invention;

FIG. 2L illustrates a conflict resolution Module of the system 100 for multimedia based learning in a computer-based environment, according to one embodiment of the present invention;

FIG. 3 illustrates a snapshot of a gallery of the best compositions of the system 100 for multimedia based learning in a computer-based environment, according to one embodiment of the present invention; and

FIG. 4A, FIG. 4B and FIG. 4C illustrates a snapshot of an example of RPG Forum threads based on fiction and real life events of the system 100 for multimedia based learning in a computer-based environment, according to one embodiment of the present invention.

### BRIEF DESCRIPTION OF THE INVENTION

Embodiment of the present invention provides a system for multimedia based educational game learning for multiple users and includes a central processing unit, a set of support circuits and at least one server computer for communicating over a communication network. The server includes at least one processor configured to execute at least one set of instructions for multimedia based educational game learning, a memory device coupled to the at least one processor. Particularly, the memory device includes multiple modules configured to provide an interactive learning environment to the multiple users via the communication network and multiple databases, having stored therein the at least one set of instructions for execution by the at least one processor and an interface to provide access to the server from multiple client devices over the communication network. Particularly, the multiple modules include a content management module, a user management module, a collaboration management module, a social interaction management module, a reward module, a commerce module, a role playing gaming module, a customization module, a tools and utilities module, an artificial intelligence simulation module, a control module, and a conflict resolution module.

Embodiment of the present invention provides, a method for multimedia based educational game learning for multiple users, includes the steps of creating multiple multimedia compositions by at least one user, and executing a set of instructions to combine at least one link selected from a text, an image, an audio, and a video based link to the multiple multimedia compositions, retrieving the at least one user information from multiple databases, including relational databases, tracking progress of the multiple users, and managing multiple user groups and multiple user domains and facilitating an user collaboration on at least one level, conducting at least one competition for a best multimedia composition and determining at least one partner and at least one sponsor for the at least one competition, facilitating at least one rating by the multiple users of an entire composition, and at least one of component and sub-components of the multimedia composition, wherein the at least one of component and sub-components include at least one part of text, image, audio, and video-files according to multiple criteria parameters, executing a set of instructions to rate multiple comments of the multiple users and multiple juries, providing the multiple users as a reward at least one of a part of advertising, multiple sponsor links, multiple licensing revenues, and multiple competition prizes, providing the multiple users with multiple commerce capabilities and means for forming at least one of cooperatives, franchises, and means for evaluating and paying tax, combining at least one of multiple entertainment and educational games, multiple physical games, multiple role playing games (RPG) and multiple RPG Forum games, providing at least one of a customized content and a form according to at least one author preferences and at least one user preferences, processing at least one of a digital image, an audio, a video, and multiple text files to achieve at least one desirable effect, analysing user behavior based on user-computer interaction and a multiple user preferences, determining the multiple users with a desirable set of personality trait parameters, and to simulate human behavior, processing multiple online forms with multiple user comments and complains, analysing at least one user's behavior based on multiple user's input means. Further, the multiple users' input means includes a user's input to multiple forms, a mouse control and scroll, and a web page loading. The method further includes the steps of selecting at least one link from the multiple databases, multiple computer interaction habits of the at least one user, multiple user selection of color scheme, font, preferred types of text, music, image, and video-files, at least one rating of the at least one user composition, at least one comment, at least one collaboration habit and the like, matching at least two users with at least one of a similar behavior, opposite values, experience, any specified parameters of habits, multiple preferences of the multiple users and the like and mimicking human behavior in playing against at least one computer means.

Embodiments of the present invention further provides that, the content management module is configured to provide multiple learning resources, means for creating a multiple online multimedia compositions, showcasing and rating of at least one of the multiple online multimedia compositions and at least one portion of the multiple online multimedia compositions. The user management module is configured to retrieve user information from the multiple databases, track progress of the multiple users, and manage multiple user groups and the multiple user domains. The collaboration management module is configured to facilitate user collaboration on at least one level. Particularly, the at least one level includes an individual level and a team level. Further, the collaboration management module conduct at least one competition for a best multimedia composition and determine at least one partner and at least one sponsor for the at least one competition, and determine at least one mentor and at least one consultant for at least one individual user and at least one team. The social interaction management module is configured to determine multiple user friends ready to offer help by retrieving information about the multiple user friends from the multiple databases, interact with the multiple friends by using at least one interaction platform. Particularly, the at least one interaction platform includes a chat, a discussion forum, and any other type of user interaction platform, and managing the multiple user groups. The reward module is configured to provide the multiple users as a reward at least one of a part of advertising, multiple sponsor links, multiple licensing revenues, and multiple competition prizes. The commerce module is configured to provide the multiple users with multiple commerce capabilities and means for forming at least one of cooperatives, franchises, and means for evaluating and paying tax, and the role playing gaming module is configured to combine at least one of a multiple entertainment and educational games, multiple physical games, multiple role playing games (RPG) and multiple RPG Forum games. The customization module is configured to provide at least one of a customized content and a form according to at least one author preferences and at least one user preferences and the tools, and utilities module is configured to process at least one of a digital image, an audio, a video, and multiple text files to achieve at least one desirable effect. The artificial intelligence simulation module is configured to analyse user behavior based on user-computer interaction and the multiple user preferences, determine the multiple users with a desirable set of personality trait parameters, and to simulate human behavior. The control module is configured to control content, plagiarism, cyber bulling, and other negative behaviors, and encourage collegial user interaction and other positive behaviors, and the conflict resolution module is configured to process multiple online forms with multiple user comments and complains.

In another embodiment of the present invention, the educational gaming system is configured for engaging senior users in cognitive exercises by providing resources for music therapy, art therapy, poetry therapy, dance therapy, and other expressive therapies and further collaborating with family members, peers, and caregivers.

In yet another embodiment of the present invention, the educational gaming system is configured for engaging corporate users in learning safety, innovation, languages, and professional skills by providing multiple resources for creating multimedia compositions on the subjects.

In yet another embodiment of the present invention, the educational gaming system is configured for engaging multiple young users in learning reading, arts, music, and other fields and further collaborating with family members, peers, and caregivers.

In yet another embodiment of the present invention, the educational gaming system is configured for engaging multiple users in learning ancestry and further collaborating between family members.

In yet another embodiment of the present invention, the educational gaming system is configured to help users to find users with similar interests, preferences, and experiences or with desirable set of personality traits, social status, ethnical background, or any other desirable personal characteristics. Particularly, the multiple criteria parameters include content and presentation form, and grading by multiple instructors.

In yet another embodiment of the present invention, the method for multimedia based learning in a computer-based gaming environment further includes the steps of selecting one or more personal preferences, creating multimedia compositions by the user and/or modifying existing compositions stored in the first database if allowed by the original authors, receiving financial rewards through posting advertisements and/or sponsor links on user's pages, receiving licensing fees for the original content, and competitions, requesting or offering help to improve compositions, employing multiple online educational games and participating in a variety of RPG and RPG Forum games including, Everyday Life Game, Honest Game, Invention Game, other games related to users' everyday life and the like.

Therefore, as may be seen, various embodiments of the present invention provide multiple advantages over prior art, such as, for example, but not limited to, payment of licensing fees to users, helpful comments and suggestions for improving other users' compositions as rated by the original authors and/or jury, and the like.

### DETAILED DESCRIPTION OF THE EMBODIMENTS

Embodiments of the present invention relate to educational gaming systems and methods, providing an active learning environment to multiple users, wherein various incentives are provided to the users for enhanced engagement in learning, such as, for example, but not limited to, novel reward mechanisms, serious game elements, user collaboration, social interaction and the like. Furthermore, various embodiments of the present invention provide improved learning outcomes due to engagement of users' creativity and use of Arts.

Various methods and systems disclosed by the present invention may assume a variety of physical and logical configurations, including a variety of computers employing a number of different operating systems and network configurations. In one embodiment, an educational gaming system includes a server and at least one user interface. In use, the user interface may be a computer, and the educational gaming system includes multiple computers.

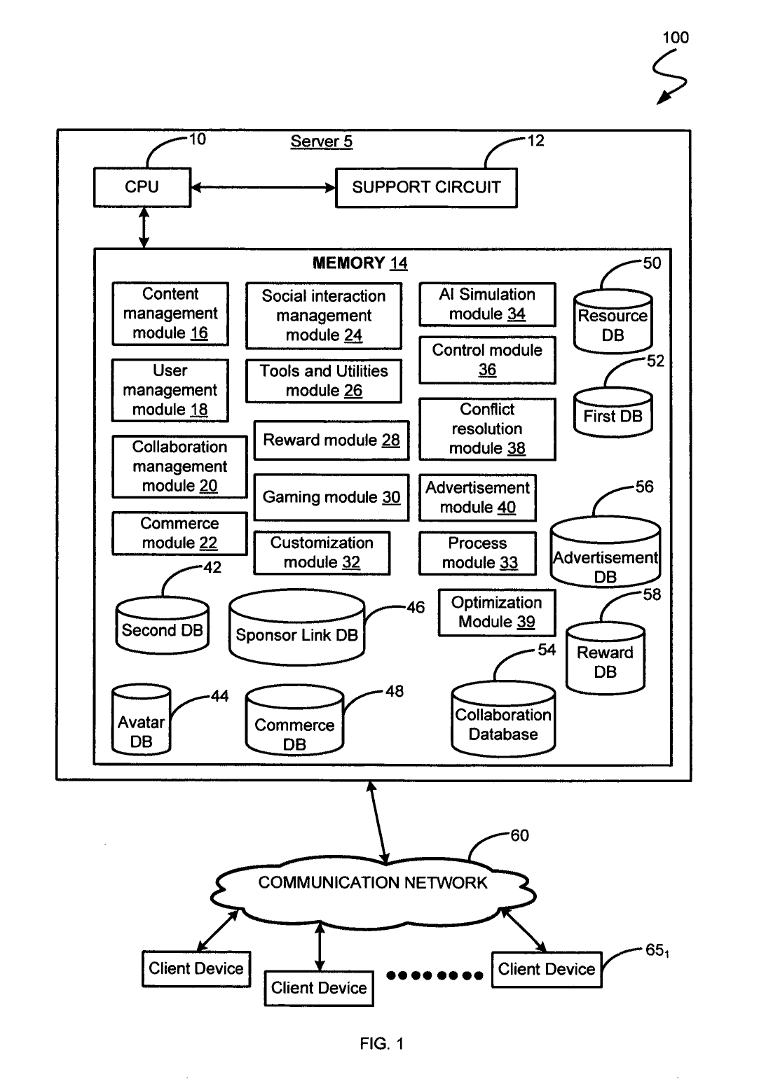

In accordance with an embodiment of the present invention, FIG. 1 illustrates a system 100 for multimedia based learning in a computer-based environment. The server 5 of the educational gaming system 100 includes a processor coupled to a data storage device. Each computer 65 of the multiple computers of the educational gaming system 100 includes a client program, or software means, which is operatively or communicatively coupled to the server 5. The system 100 for multimedia based educational game learning for multiple users includes a central processing unit 10, a set of support circuits 12 and at least one server computer 5 for communicating over a communication network 60. The server 5 includes at least one processor configured to execute at least one set of instructions for multimedia based educational game learning, a memory device coupled to the at least one processor. Particularly, the memory device includes multiple modules configured to provide an interactive learning environment to the multiple users via the communication network 60 and multiple databases, having stored therein the at least one set of instructions for execution by the at least one processor and an interface to provide access to the server 5 from the multiple client devices 65₁, . . . , 65_{N} over the communication network 60. In one embodiment, the multiple modules include a content management module 16, a user management module 18, a collaboration management module 20, a social interaction management module 24, a reward module 28, a commerce module 22, a role playing gaming module 30, a customization module 32, a tools and utilities module 26, an artificial intelligence simulation module 34, a control module 36 and a conflict resolution module 38.

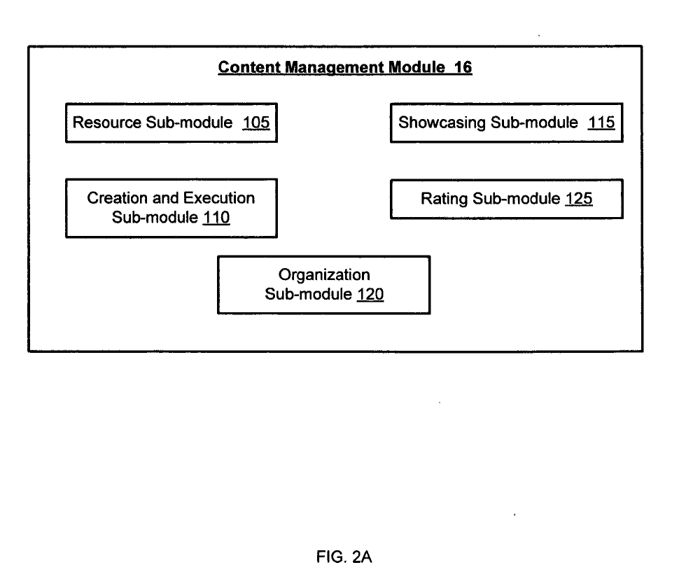

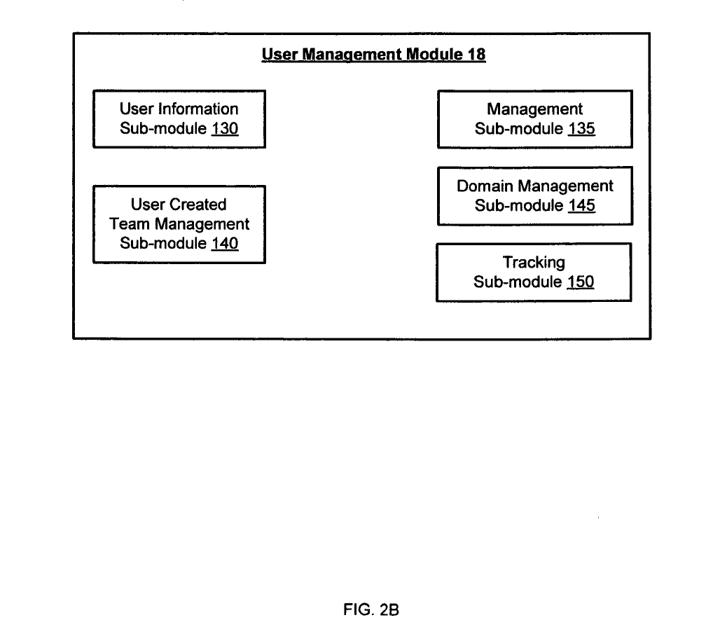

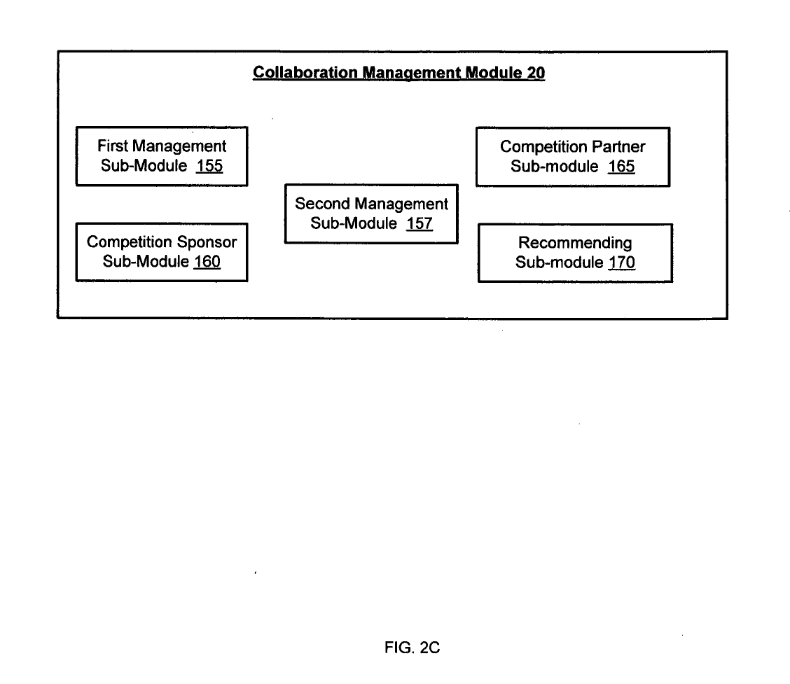

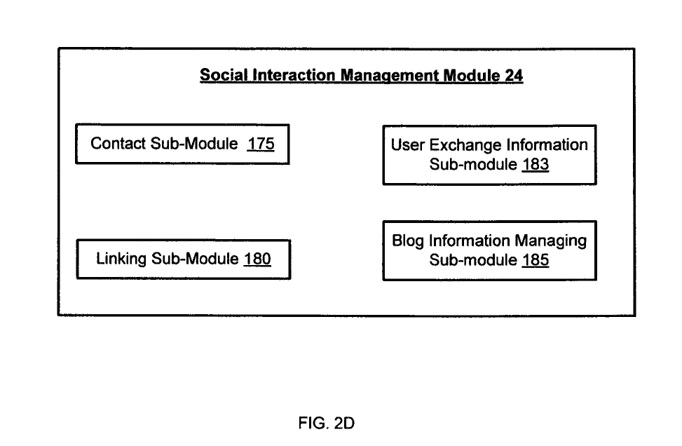

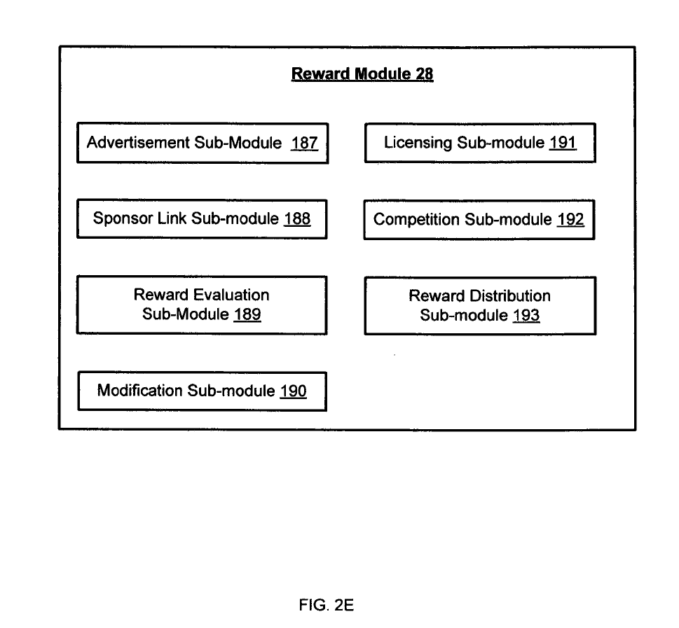

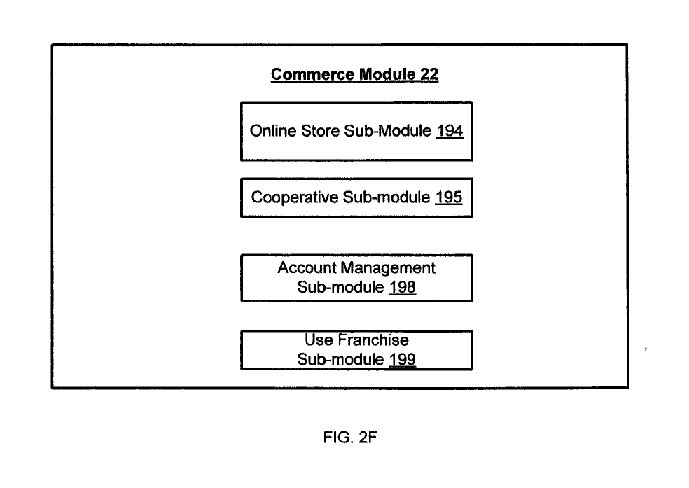

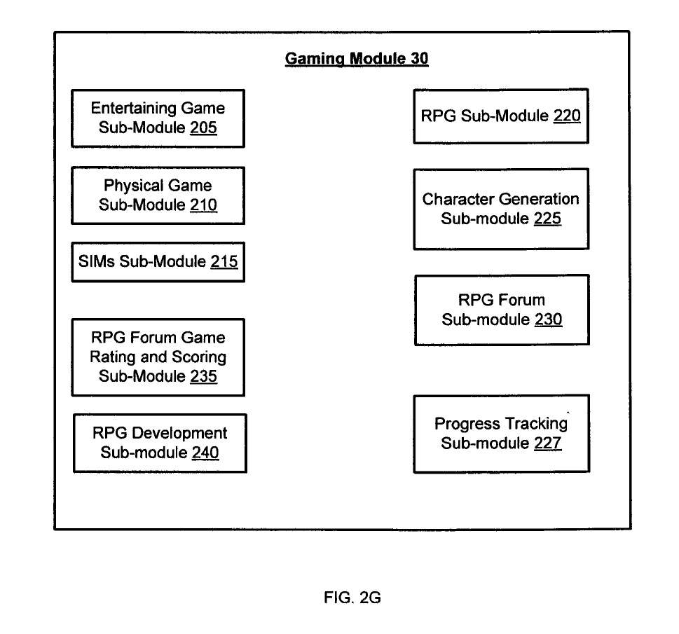

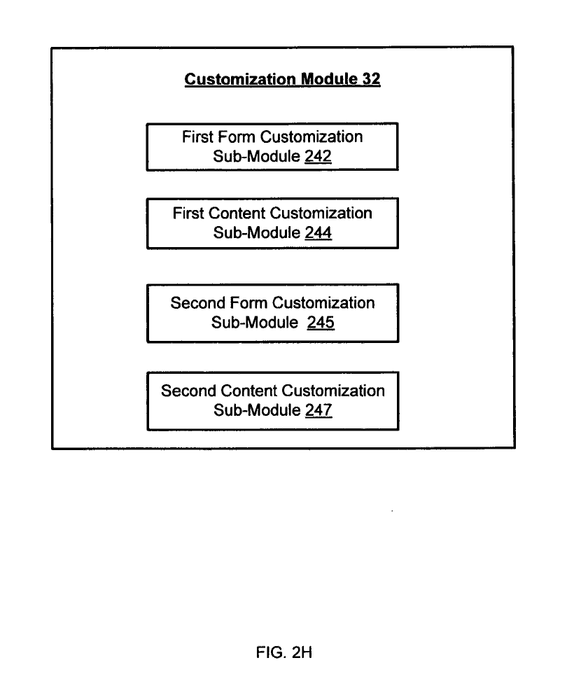

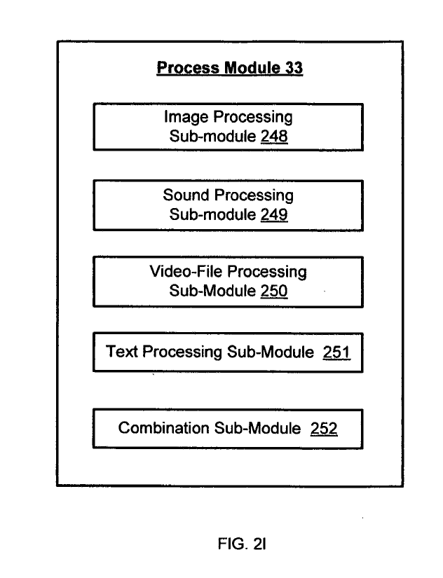

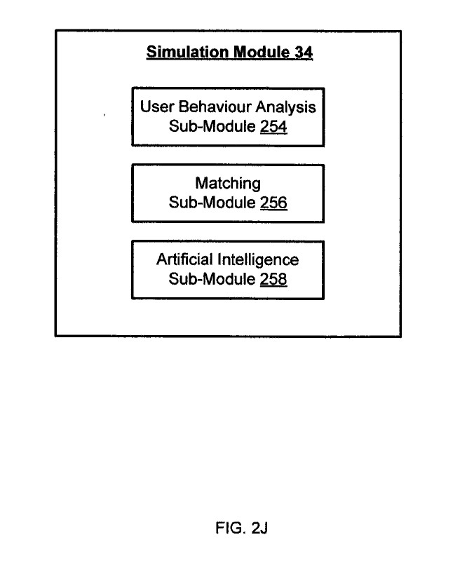

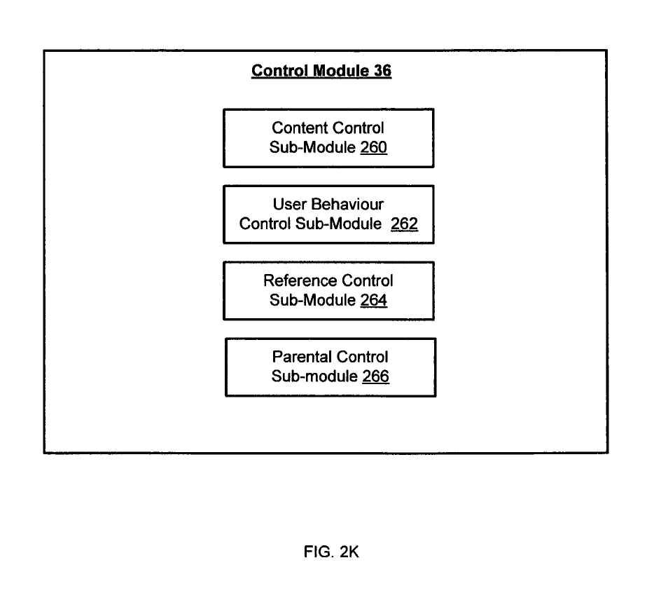

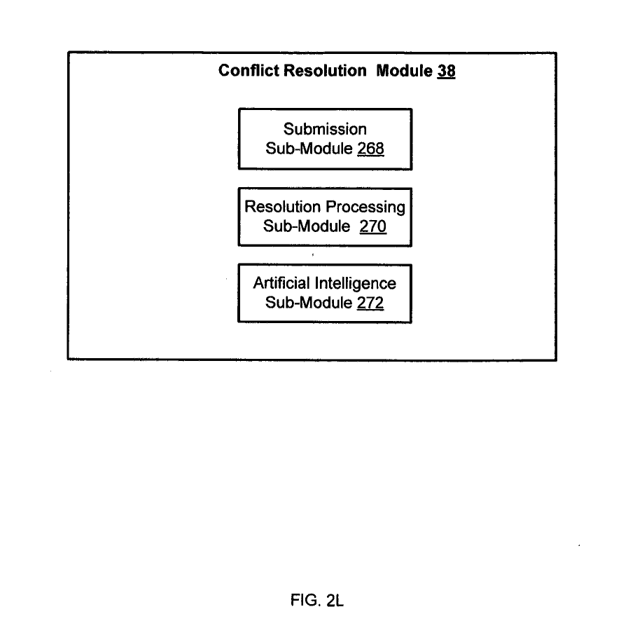

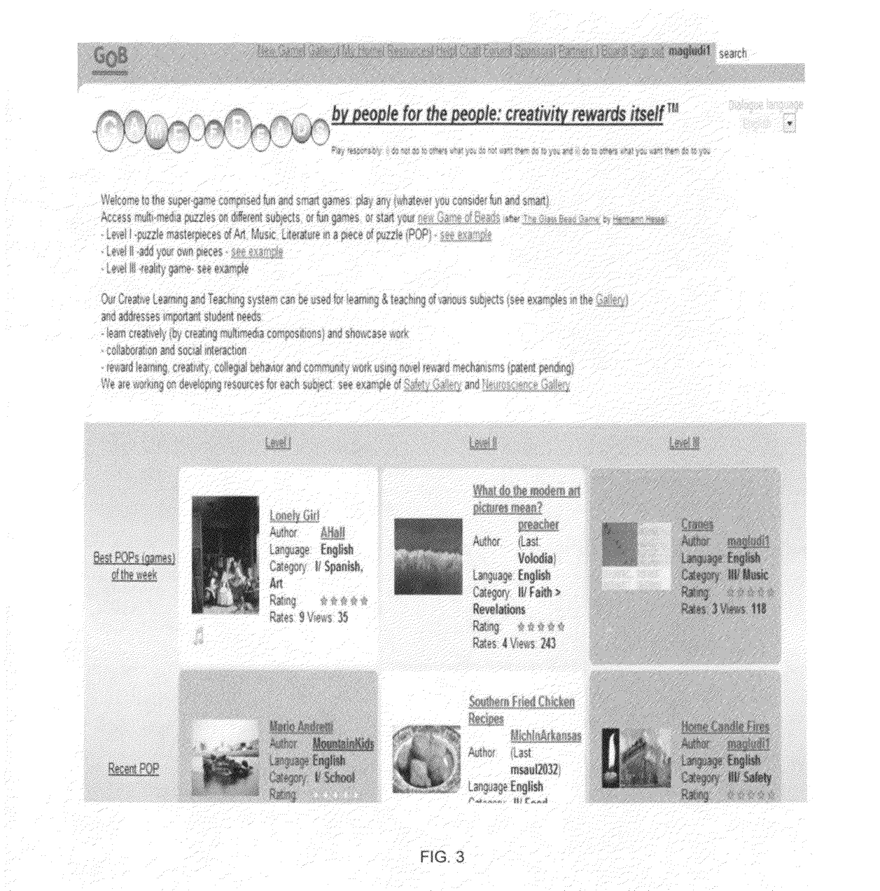

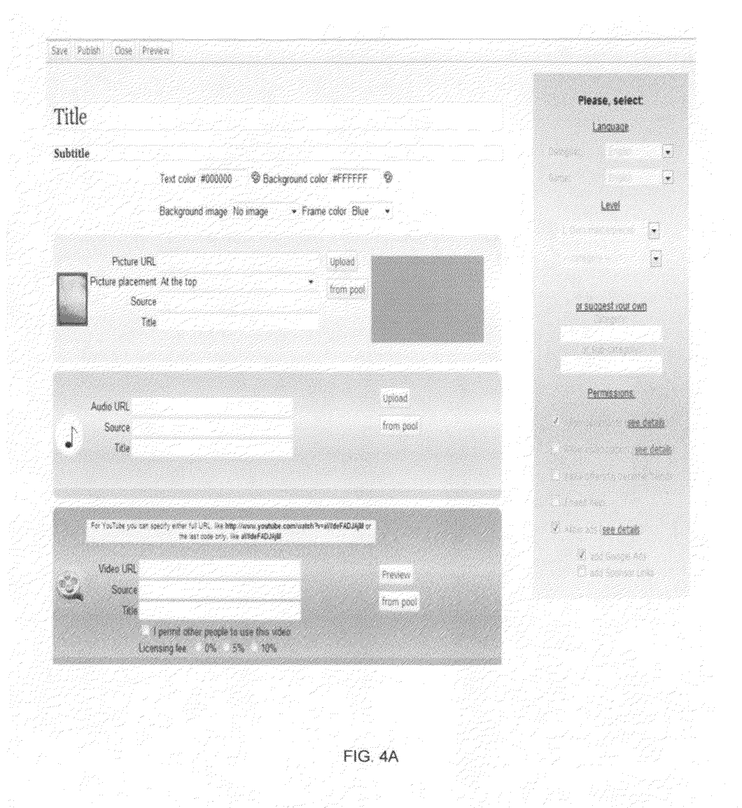

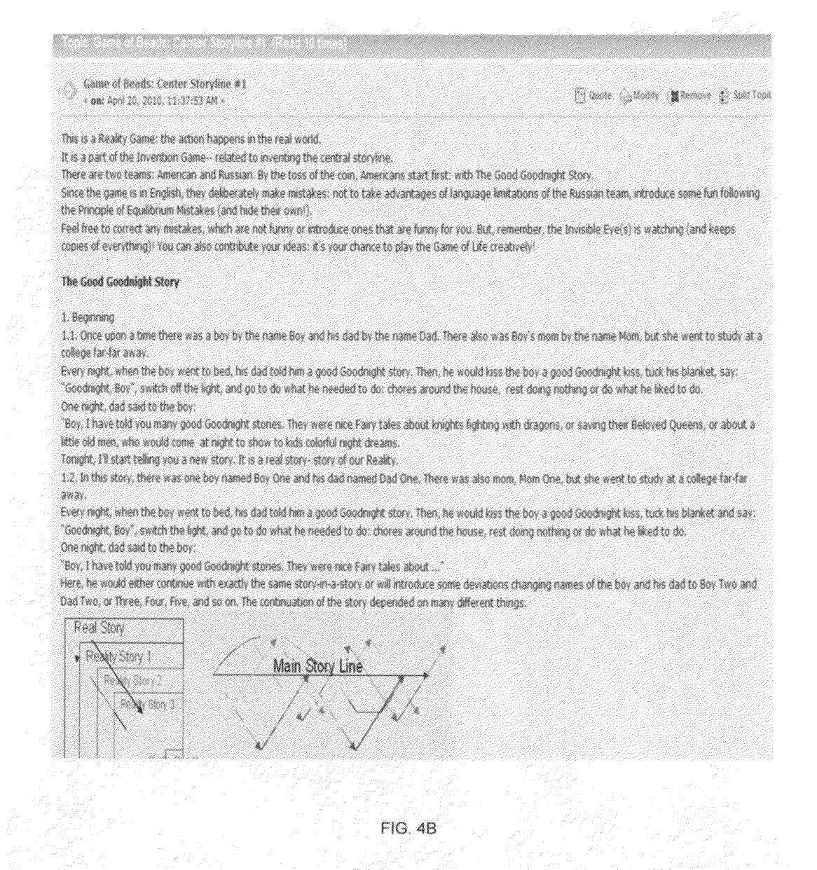

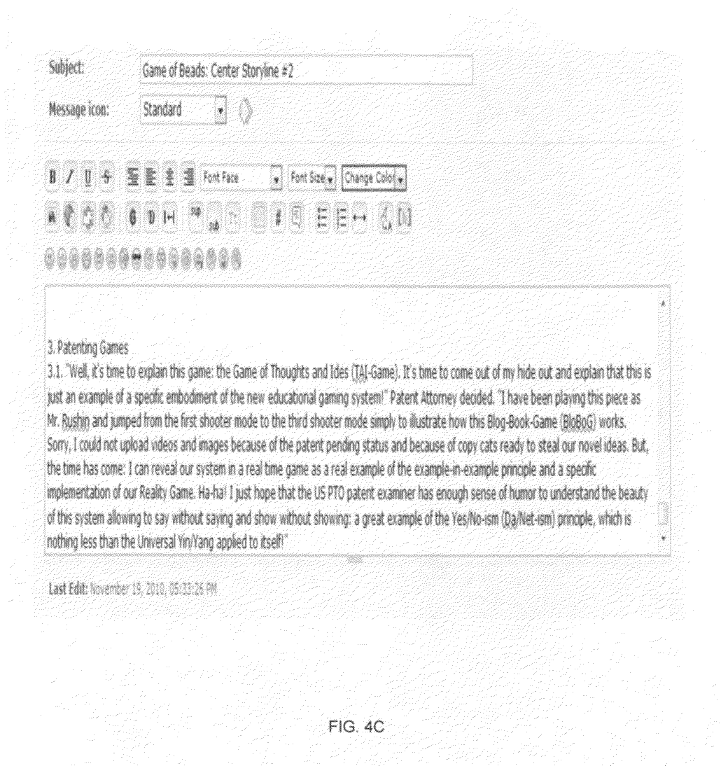

In one embodiment of the present invention, the content management module 16 as illustrated in FIG. 2A of the present invention is configured to provide multiple learning resources, means for creating multiple online multimedia compositions, showcasing and rating of at least one of the multiple online multimedia compositions and at least one portion of the multiple online multimedia compositions. The user management module 18 is configured to retrieve user information from the multiple databases 42, 44, 46, 48, 50, 52, 54, 56, 58 track progress of the multiple users, and manage multiple user groups and the multiple user domains. The collaboration management module 20 is configured to facilitate user collaboration on at least one level. Particularly, the at least one level includes an individual level and a team level. Further, the collaboration management module 20 conduct at least one competition for a best multimedia composition and determine at least one partner and at least one sponsor for the at least one competition, and determine at least one mentor and at least one consultant for at least one individual user and at least one team. The social interaction management module 24 is configured to determine multiple user friends ready to offer help by retrieving information about the multiple user friends from the multiple databases 42, 44, 46, 48, 50, 52, 54, 56, 58 interact with the multiple friends by using at least one interaction platform. Particularly, the at least one interaction platform includes a chat, a discussion forum, any other type of user interaction platform, and managing the multiple user groups. The reward module 28 is configured to provide the multiple users as a reward at least one of a part of advertising, multiple sponsor links, multiple licensing revenues, and multiple competition prizes. The commerce module 22 is configured to provide the multiple users with multiple commerce capabilities and means for forming at least one of cooperatives, franchises, and means for evaluating and paying tax, and the role playing gaming module 30 is configured to combine at least one of a multiple entertainment and educational games, multiple physical games, multiple role playing games (RPG) and multiple RPG Forum games. The customization module 32 is configured to provide at least one of a customized content and a form according to at least one author preferences and at least one user preferences. The tools and utilities module 26 is configured to process at least one of a digital image, an audio, a video, and multiple text files to achieve at least one desirable effect. The artificial intelligence simulation module 34 is configured to analyse user behavior based on user-computer interaction and the multiple user preferences, determine the multiple users with a desirable set of personality trait parameters, and to simulate human behavior. The control module 36 is configured to control content, plagiarism, cyber bulling, and other negative behaviors and encourage collegial user interaction and other positive behaviors and the conflict resolution module 38 is configured to process multiple online forms with multiple user comments and complains.

In one embodiment of the present invention, one or any number of the multiple computers 65₁, . . . , 65_{N} is coupled to the server 5 over a local area network (LAN), e.g. an Ethernet network. In an alternative embodiment, one or any number of multiple computers 65₁, . . . , 65_{N} are coupled to the server 5 over a wide area network (WAN). Additionally, one or any number of multiple computers may be coupled to the server 5 over the public switched telephone network (PSTN) and/or the Internet. In one embodiment, by way of example and not by way of limitation, the multiple computers may communicate with one another and the server 5 using transmission control protocol/Internet protocol (TCP/IP).

In one embodiment of the present invention, the data storage device of the server 5 includes a memory 14, which is structured to store various instructions stored therein, which when executed by a processor of the server 5, enable the users, to upload multiple creative assets created by the users on an interactive platform, to receive feedback from other users regarding their creative assets uploaded on the interactive platform, to avail financial benefits from their creative assets uploaded on the interactive platform, and the like. In one embodiment, the interactive platform is a website hosted on the Internet.

In one embodiment of the present invention, the data storage device of the server 5 further includes a plurality of databases and data modules. The multiple databases, including relational databses, store text, image, sound, video-files, and, links to on-line collections of text, image, sound, and video-files, including, but not limited to Art museums, History museums, Emblems museums, digital libraries, musical archives, and any other kind of repositories of text, image, sound, and video-files. Further, a resource database 50 stores sponsor links.

FIG. 2A illustrates the Content Management Module 16 of the system 100 for multimedia based learning in a computer-based environment, according to one embodiment of the present invention. The content management module 16 includes a resource sub-module 105, a creation and execution sub-module 110, a showcasing sub-module 115, an organization sub-module 120, and a rating sub-module 125.

The content management module 16 includes a resource sub-module 105 for retrieving at least one data from the multiple databases 50. The resource sub-module 105 includes a set of instructions for creation of multimedia compositions and user domains, tutorials on various subjects, training materials employed by the present invention, sets of specific examples of multimedia compositions created by using the present invention, and databases of text, image, audio, and video-files that can be used for creation of said multimedia compositions as well as links to Web sites providing said types of files. Particularly, the present invention provides the multiple resources including databases of the Internet based materials and relational databases organized according to the degree of relevance of text, image, audio, and video components needed to create the multimedia composition as evaluated by the multiple users. The authors of the multimedia compositions select one or more components with different degree of relevance as evaluated based on input from viewers of the multimedia compositions thus enabling the users to author compositions tailored for viewers with one or more preferences.

Particularly, the creation and execution sub-module 110 configured to create the multiple multimedia compositions by the at least one user, and executing a set of instructions to combine the at least one of text, image, audio, or video-file or links to the multiple files. The one or more multimedia compositions created at the client devices 65 are created with any of the available software programs available in the art and are further linked to the present invention by the creation and execution sub-module 110. The showcasing sub-module 115 providing means for displaying user created compositions in public or private password protected galleries and sub-galleries hierarchally arranged for multiple topics within at least one gallery related to a same field or subject. The organization sub-module 120 configured to organize relevant data by subjects, topics and the like and executing a set of instructions to perform at least one of a keyword searching, filtering the at least one multimedia composition on at least one of a subject and a topic stored in the multiple databases of the present invention. Further, the organization sub-module 120 provides a set of templates designed for different topics, including templates designed by other users offered for use without charge, licensing fee, or a payment. The rating sub-module 125 configured to facilitate at least one of rating by the multiple users, an entire composition, at least one of components and sub-components of the composition, and executing a set of instructions to rate multiple comments of the multiple users and multiple juries, wherein the multiple criteria parameters include content and presentation form, and grading by multiple instructors. Further, the rating sub-module 125 has a set of instructions to enable users to design the rubrics, particularly, using various templates for rubrics, select from a database of existing rubrics and modify the rubrics as needed.

Particularly, the multiple databases include at least one of text, image, audio, video-files, multiple links to a multiple online resources, multiple tutorials on creation of online multimedia compositions, and multiple teaching courses for multiple fields and multiple topics include a teaching data and a testing data. The at least one of components and sub-components include at least one part of text, image, audio, and video-files according to multiple criteria parameters. Moreover, the present invention enables the users to customize the appearance of the authoring tool and select one or more elements enabling users to include advertising links, sponsor links, information on licensing users' original content, permission to make modifications by other users, or provide comments, apply a digital stamp for example a digital watermark to prevent unauthorized use of the user's original material, apply a digital signature and perform other important functions. Therefore, as may be seen, the content management module 16 provides multiple benefits to the users, including, but not limited to, greater learning opportunities by including both proprietary and non-proprietary resources, optimization of each creation by allowing for rating of each component, bridging educational and entertainment games by a universal score, and the like. Additionally, the content management module 16 includes learning resources, while existing virtual schools provide teaching resources only.

FIG. 2B illustrates the User Management Module 18 of the system 100 for multimedia based learning in a computer-based environment, according to one embodiment of the present invention. The user management module 18 is having a set of instructions for managing one or more individual users, group users, and organizational users. Particularly, the user management module 18 includes a user information sub-module 130, a tracking sub-module 150, a management sub-module 135, a user created team management sub-module 140, and a domain management sub-module 145. The user information sub-module 130 is configured to provide at least one user authentication, and executing a set of instructions to create multiple user accounts, including paid membership accounts, storing and displaying user information according to user preferences. The present invention further provides new means for graphical representation of user's personal information in a form of a virtual Life Road. The users can create points on the virtual life road corresponding to real life events and places, upload to their domains multimedia compositions, pictures, videos, or any other files and link them to the multiple points on the virtual life road. The viewers can access said documents via said links, leave their comments, rate said documents, and perform other collaborative actions. Further, the tracking sub-module 150 has a set of instructions for tracking user progress in learning and gaming activities. Particularly, the tracking sub-module 150 is configured to track a user progress for the multiple users from at least one common organization according to multiple parameters.

In one embodiment of the present invention, the multiple parameters for tracking user's progress in learning various subjects include class, grade, organization department, user's names, rating of their multimedia compositions, grading by teachers, links to said compositions, comments, and any other pertinent information.

The management sub-module 135 is configured to divide a group or organizational users in multiple teams by executing multiple algorithms and executing at least one a set of instructions to provide at least one of a random selection, a specified group size, an alphabetical order of multiple user names, and the like. Particularly, the management sub-module 135 has a set of instructions for forming user groups including individual users, dividing group or organizational users in teams according to different algorithms including, but not limited to random selection, specified group size and alphabetical order of user names, or any other criteria. Moreover, the user created team management sub-module 140 has a set of instructions for enabling the user to invite at least one other user on a team and manage the team. Particularly, the team includes at least one of a player guild, a player society, or any other organization of users involved in a combination of gaming and learning activities. The domain management sub-module 145 has a set of instructions for enabling multiple authorized users to create, modify or remove at least one sub-domain within at least one authorized user domain. Particularly, the at least one sub-domain includes at least one of multiple galleries for multiple subjects, at least one gallery for at least one topic and a project, multiple family galleries with at least one information resource, and multiple showcase multimedia compositions.

In accordance with an embodiment of the present invention, the multiple parameters include a class, a grade, an organization department, multiple users names, rating of the multiple multimedia compositions, grading by multiple teachers, multiple links to the multiple multimedia compositions, multiple comments, and the like.

FIG. 2C illustrates the Collaboration Management Module 20 of the system 100 for multimedia based learning in a computer-based environment, according to one embodiment of the present invention. The collaboration management module 20 includes a first management sub-module 155, a second management sub-module 157, a competition sponsor sub-module 160, a competition partner sub-module 165, and a recommending sub-module 170. Particularly, the first management sub-module 155 has a set of instructions for managing collaboration on the same multimedia composition on at least one of an individual level and a team level and the second management competition sub-module 157 is configured to conduct multiple online competitions for selecting a best multimedia composition, create rubrics and specify multiple judging criteria, invite multiple judges and enter a score. The first database 52 of the present invention stores original compositions of the multiple users and a collaboration database 54 of the present invention stores one or more modified compositions. Further, the first management sub-module 155 retrieves one or more original compositions from the first database 52 and one or more modified compositions from the collaboration database 54. The first management sub-module 155 enables multiple viewers of online compositions to offer one or more improvements if the respected option is selected by the original author of the composition. For example, the author receives an e-mail message notifying about changes made to the original composition and a link to the modified composition, which is also displayed on a thumbnail image of the composition posted in a gallery. Further, the author has an option to accept or reject suggested changes and remove the link to the modified composition.

Moreover, the second management sub-module 157 has a set of instructions for managing competitions between individual, group, or organizational users. Moreover, the second management sub-module 157 is configured to create and dedicate separate space for each competition. Further, the multimedia compositions created by users at the client devices 65 are displayed at each dedicated separate space by the second management sub-module 157. The users select a template for the competition and customize the web pages by using the one or more webpage editing tools. In operation, the users create their own instructions, competition rules, lists of rewards, databases of sponsors and advertisers, and other webpages facilitating conducting of on-line competitions. Furthermore, the second management sub-module 157 provides means for participants to register for the competition or for organizers (owners of competitions) to invite participants. In operation, the rating sub-module 125 of the content management module 16 is configured to invite judges, provide rating means to rate the multimedia compositions to the viewers, judging panels and the like. Further, the second management sub-module 157 is configured to display on the interface of the client device 65 the highest rated multimedia compositions, most viewed compositions, multiple winning compositions, and compositions selected by any criteria, for example, but not limited to viewers' choice. Subsequently, the winning composition is rewarded by retrieving a reward from a reward database 58 of the competition. Particularly, the one or more rewards include multiple monetary prizes, multiple gift cards, multiple scholarships, multiple products, multiple discounts to products, and any other type of rewards. Further, the second management sub-module 157 is configured to provide a set of templates for honor certificates, a set of templates for inviting sponsors to support competitions, means for their customizing, and electronic means for delivering to one or more recipients.

The competition sponsor sub-module 160 is configured to determine multiple sponsors providing prizes in at least one form of monetary, product, discount coupons, scholarship, and multiple rewards, and add sponsor links to the user created compositions. Particularly, the competition sponsor sub-module 160 provides sponsor competitions to engage users in learning and creative activities. The sponsors can start a competition or sponsor existing competitions by offering rewards to users for creating winning compositions. Further, the sponsor link database 46 is a database of sponsors, from which the users retrieve one or more links to post on their pages.

In yet another embodiment of the present invention, the competition sponsor sub-module 160 is configured in such a way that one or more links of sponsors supporting specific competitions are automatically retrieved and added to multiple composition pages created by the user participants. Particularly, the sponsors determine sponsor partners to support a competition and the sponsors determine non-profit organization partners that will be recipients of the sponsor's support and educational organization or other type of partners whose members will create multimedia compositions and post one or more links of the sponsors and/or links of the non-profit organizations on their pages.

In one embodiment of the present invention, the competition partner sub-module 165 is configured to determine multiple partners and challenge at least one competitor team. Particularly, the competition partner sub-module 165 is configured to determine one or more partners to compete against or together with against other individual, group, or organization users. The competition partner sub-module 165 retrieves one or more potential partners from the database based on one or more competition parameters including keywords, geographic location, type of institution, and the like. Further, the competition partner sub-module 165 is configured to provide cross linking of partners' domains and sub-domains, including galleries, Web sites, and other domains on the Internet and has a set of instructions to provide templates for inviting or challenging partners, means for customizing templates or creating invitations and delivering the invitations electronically to the partners and competitors. The recommending sub-module 170 is configured to determine multiple mentors and multiple consultants providing expert opinion and help with creating the multiple multimedia compositions. Particularly, the recommending sub-module 170 is configured for providing sponsored competitions for display to a user based on information stored in the first database 52. Moreover, the recommending sub-module 170 is configured to recommend topics of competitions, information on jury members for display to a user based on information stored in the first database 52. Moreover, the recommending sub-module 170 is configured to display sponsor information including, but not limited to, links to sponsored products and the like along with the multimedia composition to the user via the client device 65. Furthermore, the recommending sub-module 170 is configured to facilitate collaboration between multiple users by displaying information for a qualified user registered as a mentor, who is an expert in the field providing guidance to users without charge. The recommending sub-module 170 is configured to send message to the selected qualified user or a panel of qualified users and exchange information with the qualified user or the panel with regard to users' compositions or any other items of interest. Further, the recommending sub-module 170 provides a set of instructions for collaboration between users and consultants, providing means to individual, group, or organizational users to select a qualified user registered as consultant, contact the qualified user, and exchange information with the qualified user with regard to users' compositions or any other items of interest, and provide payment to the consultant based on the mutually accepted conditions. Consequently, the present invention provides multiple benefits to the users, including, but not limited to, additional incentives for learning by providing multiple competitions, high quality compositions to be recommended by consultants and mentors, and the like.

FIG. 2D illustrates a Social Interaction Management Module 24 of the system 100 for multimedia based learning in a computer-based environment, according to one embodiment of the present invention. The social interaction management module 24 is configured for managing social interaction of individual users, group users, and organizational users. Particularly, the social interaction management module 24 includes a contact sub-module 175, a linking sub-module 180, a user exchange information module 183, and a blog information managing sub-module 185. The contact sub-module 175 is configured to contact the multiple users determined as friends, execute a set of instruction to share the at least one multimedia composition information in a real time and create at least one new multimedia composition by the friends, contact the multiple users based on at least one share parameter to rate at least one of the multiple user's original multimedia compositions, and multiple users modified multimedia compositions proposed by the multiple users in real time. Particularly, the contact sub-module 175 retrieves information about the multiple users determined as the at least one friend from the user database 52 and the at least one share parameter includes the multiple users sharing at least one topic of interest and the like or users belonging to the same group, such as a team, guild, society and the like in the RPG or RPG Forum. Further, the information exchanged between users through e-mails, chat, and any other form of communication is presented in a format of the Reality Game, for example, as a part of the Everyday Game, or an E-pistle game based on exchanged e-mail messages, chat, or any other type of electronic information exchanged between users. Consequently, the contact sub-module 175 provided by the present invention enables users to present any exchanged information in a format of a Reality Game thereby increasing efficiency of use of said information. The linking sub-module 180 is configured to at least link and cross link the at least one multimedia composition, and any other posted information by retrieving the sponsor links from the resource database 50, the original compositions from the first database 52 and the modified compositions from the collaboration database 54 in real time and display the at least one link to the one or more users via the client devices 65. Further, the users can cross-link dots on their virtual Life Road, with the links presented in a graphical form, for example, but not limited to a Friendly Map. Consequently, the linking sub-module 180 enables users to view and display information related to other users identified as friends in a graphical form.

In operation, the user exchange information sub-module 183 is configured to facilitate exchange of information between users through chat rooms, bulletin boards, links to the popular systems for social interaction, and the like. Particularly, the users creating their domains showcasing multimedia compositions create, choose a template, and customize chat rooms, bulletin board, links to the popular systems for social interaction, and the like in each of the domains. The design and a set of templates for chat rooms and bulletin boards reflect specific focus of the user's domain, including, but not limited to various subjects, various games, particularly, Reality Games. The blog information managing sub-module 185 is configured to manage blog information of at least one of multiple real societies, multiple virtual societies, multiple guilds and multiple organizations and to read the blog information and upload the content to the website according to the blog information. Consequently, the blog information managing sub-module 185 enables users to provide information on one or more topics through hierarchally arranged one or more blogs in user created domains and incorporate information posted in the blogs as a part of Reality Game.

FIG. 2E illustrates a Reward Module 28 of the system 100 for multimedia based learning in a computer-based environment, according to one embodiment of the present invention. The reward module 28 includes at least one of an advertisement sub-module 187, a sponsor link sub-module 188, a reward evaluation sub-module 189, a modification sub-module 190, a licensing sub-module 191, a competition sub-module 192, and a reward distribution sub-module 193. The advertisement sub-module 187 and the sponsor links sub-module 188 are configured for providing advertisement links on the interface of user's composition by retrieving one or more advertisement from the advertisement database 56 or sponsor links from the sponsor links database 46. However, the number of allowed advertisements and sponsor links and type of advertisements and sponsor links depends on the user's rank reflecting user's learning, creativity, and community service and type of membership. Particularly, The advertisement sub-module 187 and the sponsor link sub-module 188 are configured to enable the multiple users to conduct at least one of the following steps creating a multiple advertisements and multiple sponsor banners, combining multiple media, storing at least one of multiple existing advertisements and multiple sponsor banners in at least one link database 46, 56 that includes multiple advertisement links and multiple sponsor banners, adding the multiple advertisement links and/or the multiple sponsor links to the at least one link database 46,56 determined by at least one users' rank and membership level, accessing the at least one link database 46, 56 determined by the users' rank and membership level, selecting the multiple advertisement links retrieved from the at least one link database 46, 56 determined by the users' rank and membership level, providing at least one link selected from the multiple advertisement links and/or the multiple sponsor links on the interface of the at least one client device 65 along with the user's multimedia composition in a user defined location and a user defined format with a preference of the user defined location and user defined format determined by the users' rank and membership level. In operation, one or more payments made to the users in the form of rewards according to a specified algorithm taking into consideration a number of views, rating of the composition, user's rank and type of membership. Further, the reward mechanisms include, but are not limited to advertising, sponsor links fees, lottery rewards, and one or more types of rewards. The one or more types of rewards, includes a monetary reward, a non-monetary reward, scholarship, bonds, and product discounts. Consequently, the advertisement sub-module 187 and the sponsor links sub-module 188 are configured to provide financial incentives for users to create high quality compositions attracting viewers' interest and traffic through the user's pages. The reward module 28 further includes the reward evaluation sub-module 189 configured to evaluate corresponding reward made to the multiple users in a form of at least one reward according to at least one of a specified algorithm, multiple second reward parameters and rating of the multiple multimedia compositions. The reward algorithm is optimized for different types of individual and team users. For example, the score of users from one organization, such as a class, a school, a company and the like who are on one team reflects progress of the whole team. This encourages collaboration of team members, mutual support, and improves retention, thereby improving student retention and reducing employee turn over.

In accordance with an embodiment of the present invention, the multiple second reward parameters include advertising, multiple sponsor links, number of views and composition rating, multiple licensing fees, and community service including, but not limited to reporting multimedia compositions with an inappropriate content, multiple posted links of non-profit organizations or their donors and sponsors, and multiple multimedia compositions promoting social cause.

Particularly, the modification sub-module 190 is configured to add, modify the at least one sponsor links retrieved from the resource database 50 and the licensing sub-module 191 is configured to provide license to at least one user of at least one user's original text, audio, image, video-file and/or multimedia composition stored in the resource database 50 for a specified payment gateway with a licensing fees determined by at least one of a fixed price, a percent of total revenues generated through the multiple advertising links and the multiple sponsor links posted along with the multimedia composition utilizing the original material. Consequently, the licensing sub-module 191 provides licensing fees to the authors of the original content defined as a per cent of advertising and sponsor links revenues generated through the composition. The competition sub-module 192 is configured to determine and provide competition prizes and the reward distribution sub-module 193 is configured to distribute reward to the multiple users with the at least one reward. Particularly, the at least one reward includes a monetary reward, a non-monetary reward, a scholarship, multiple bonds, multiple product discounts and the like.

In yet another embodiment of the present invention, the reward distribution sub-module 193 is configured to reward at least one user on the basis reward parameters based on weighted average of components reflecting user multimedia composition. The reward parameters includes at least one of rating by the users of the multimedia composition, number of viewers of the multimedia composition, number of modified versions of each multimedia composition of the multiple multimedia composition, number of links displayed to the multimedia composition and the like. Particularly, the at least one user includes a specified user, a team leader, or any other authorized user, groups of users, an organization (for example class, school and the like).

FIG. 2F illustrates the Commerce Module 22 of the system 100 for multimedia based learning in a computer-based environment, according to one embodiment of the present invention. The commerce module 22 is configured to conduct multiple transactions on the interface of the at least one client device 65. Particularly, the commerce module 22 includes an online store sub-module 194, a cooperative sub-module 195, an account management sub-module 198 and a user franchise sub-module 199. The online store sub-module 194 is configured to enable the multiple users to sell multiple products or buy the multiple products. Further, conducting multiple transactions over the communication network 60 where the multiple products that the at least one user post for sell depends on the user's gaming score and type of membership. Consequently, the online store sub-module 194 enables users to conduct online commerce as a part of the business game with web design templates corresponding to the store owner's guild, gaming association, and the like.

The cooperative sub-module 195 is configured to form multiple cooperatives includes at least one of multiple creative cooperatives, multiple consulting cooperatives, multiple educational cooperatives and the like. Particularly, the multiple creative cooperatives include at least one of multiple cooperatives producing art, music, literature and the like. The multiple consulting cooperatives includes at least one of multiple cooperatives providing technical consulting services for technical design, solution of technical problems, any other type of technical services and the like and the multiple educational cooperatives includes at least one of multiple cooperatives providing tutoring services in multiple fields includes science, art, physical fitness, professional skills and the like. Further, the cooperative sub-module 195 is configured to generate an online product listing of a plurality of user formed cooperatives. The user franchise sub-module 199 is configured to provide means to create, manage, and conduct at least one transaction in a plurality of user formed franchises. The multiple user formed franchises include a plurality of educational franchises, a plurality of creative franchises and the like. The user franchise sub-module 199 is configured to provide means to create, manage, and conduct at least one transaction in multiple user formed franchises. Particularly, the multiple user formed franchises includes multiple educational franchises, multiple creative franchises and the like. Consequently, the cooperative sub-module 195 and the user franchise sub-module 199 enable users to form cooperative and franchise organizations and to jointly conduct business based on their original materials posted on-line and expertise in various fields. Further, the cooperative sub-module 195 and the user franchise sub-module 199 enable users to benefit from bridging business and reality games, particularly, everyday game, simplify accounting, particularly, by providing tax-related forms, preventing abuse of the system.

In one embodiment of the present invention, the cooperative sub-module 195 and the user franchise sub-module 199 provide users with information about potential tax deductions related to entertainment expense, materials expense, and other similar expenses in business generating activities. Particularly, the cooperative sub-module 195 and the user franchise sub-module 199 of the commerce module 22 enable conducting online business, delivering goods sold to the buyers, providing discount coupons, and other business incentives, particularly, but not limited to in a form of rewards for creative activities and competitions.

The account management sub-module 198 is configured to provide means for generating multiple online user accounts, managing the multiple online user accounts, maintaining the multiple user's personal information, conducting at least one transaction to pay for a membership fee, evaluating tax and providing tax related information to the multiple users and transferring funds in and from the multiple online user accounts. Particularly, an online commerce database 48 stores online user accounts information data, the online product listing data and receipt/sales data for the copies of the user formed cooperatives. Consequently, the commerce module 22 of the present invention provides the users to conduct business over the Internet, form franchises and cooperatives, sell their products in on-line shops, including user created shops, deliver the goods sold to buyers, process business related forms, including but not limited to tax-related documents, sales documents, and the like.

FIG. 2G illustrates the Gaming Module 30 of the system 100 for multimedia based learning in a computer-based environment, according to one embodiment of the present invention. The gaming module 30 includes an entertaining game sub-module 205, a physical game sub-module 210, a SIMs sub-module 215, a character generation sub-module 225, a RPG sub-module 220, a progress tracking sub-module 227, a RPG Forum sub-module 230, a Role Playing Game (RPG) and RPG Forum game rating and scoring sub-module 235, a Role Playing Game (RPG) and RPG Forum game development sub-module 240. The entertaining game sub-module 205 is configured to provide at least one of multiple entertaining games and multiple links to the multiple entertaining games, and the physical game sub-module 210 is configured to provide multiple links to multiple physical games retrieved from a physical game database. Particularly, the physical game database includes at least one of a physical game, a football game, a baseball game, a soccer game, and the like. Particularly, the physical game sub-module 210 is configured to enable users to create and post in their domains multimedia compositions related physical games in which users participate, or in which said users are interested. In operation, the physical game sub-module 210 enables users to participate in fantasy games, including, but not limited to fantasy football, fantasy hockey, and the like. Further, the physical game sub-module 210 has a set of instructions to enable eligible users to bet online on one or more teams participating in various games as a part of a betting game, and a reality game. Consequently, the physical game sub-module 210 is configured to engage the users in physical games and reward active participation and creativity by providing financial rewards through advertisement, sponsor links and other types of rewards enabled by the reward module 28.

Particularly, the SIMs sub-module 215 is configured to provide means for building a virtual environment or customizing a user's gallery according to the user's preferences. The SIMs sub-module 215 is configured to enable users to build user environment including, but not limited to user created domains (galleries), graphical characters, and the like. In operation, the SIMs sub-module 215 has a set of instructions to provide means to visualize user's progress in the game in a form of a picture wall or life road on which the users modify dots linked to images, videos, text, sound files, or multimedia compositions, or collection of said mutlimedia compositions, for example, in a form of a digital book, or create new dots, upload any information, and link any dots to dots on the life road of other users. Consequently, the SIMs sub-module 215 is used not only for creating virtual objects in virtual worlds, but in reality games as well. The character generation sub-module 225 is configured to provide means for generating virtual characters, including but not limited to executing a set of instructions to provide means to retrieve at least one RPG character from the avatar database 44, weapons, tools, and other gaming items, character traits, power, and the like. Consequently, the character generation sub-module 225 enables the users to incorporate real life characters in their creations. Further, the character generation sub-module 225 is configured to engage the users in learning and creative activities. The progress tracking sub-module 227 provides means to keep track of user created multimedia compositions, their rating, number of views and the user's progress through the ranks according to a specified algorithm considering the rating and number of views of user created multimedia compositions and community service points received for posting links of non-profit organizations, reporting inappropriate content, and performing other community useful actions. Consequently, the progress tracking sub-module 227 is configured to engage users in learning and creative activities, and to cultivate collegial behavior and community service.

In one embodiment of the present invention, the gaming module 30 further includes the Role Playing Game (RPG) sub-module 220 providing means for playing RPG and RPG Forum based games incorporating at least one of images, sound, video-files, related real life events and fictional action. The RPG/RPG Forum based games include a set of virtual or real reality games, but not limited to Everyday Life Game, Invention Game, Business Game, Masquerade Game, Fantasy Sport-like Games, E-pistle Game, Polling Game developing real life skills, positive behaviours based on a set of rules, scoring system and the like. Particularly, gaming elements for playing RPG includes a set of real or virtual weapons, a protection gear, maps, dungeons, and other gaming environment elements. The RPG sub-module 220 is configured to provide means for creating guilds, professional societies and the like. The RPG/RPG Forum sub-module 230 retrieves one or more RPG/RPG Forum characters from the avatar database 44. Further, the RPG/RPG Forum sub-module 230 provides means to select, modify the gaming elements by the user, providing means to choose and change game mode, further providing means to play the game as a first shooter, a second shooter, or a third shooter format, including writing digital stories from the persepective of a first person, second, person, and third person or a group of people and incorporating a set of scenarios, templates, and algorithms for character interaction. Furthermore, the user players start at the lowest rank and progress through the rank levels based on accomplished tasks. The user players get credit points for creating multimedia compositions, including educational compositions related to their home assignments, special projects, and the like. Players also get credit points for community service. Players' pay rate related to advertising and sponsor links is determined by the player's rank. Consequently, the Role Playing Game (RPG) sub-module 220 and the RPG Forum sub-module 230 enable users to play out real life events as a part of the Role Playing Games and the RPG Forum, increase efficiency of use of information including, but not limited to e-mail messages, polls, home assignments, educational projects, and the like by incorporating the information in RPG and RPG Forum games. Subsequently, the RPG and the RPG Forum games combine elements of online games, blog, and a book. The Role Playing Game (RPG) Forum sub-module 230 providing a plurality of virtual galleries for exhibiting user created multimedia compositions related to the RPG and RPG Forum games, including, but not limited to everyday life games, a plurality of corporate games, a plurality of business games, a plurality of safety games, a plurality of sport games, and the like, and fair players gallery, unfair players gallery and the like. Further, The Role Playing Game (RPG) Forum sub-module 230 is configured to provide means for developing a common thread and multiple alternative threads by incorporating at least one of the multiple images, the multiple sound, the multiple video-files, multiple related real life events, multiple fictional action events, and means to incorporate the multiple scenarios, multiple templates includes at least one template for developing thread from at least one of a first person perspective, a second person perspective, and a third-person perspective, or a group of people, and multiple RPG Forum based format includes at least one story written by the at least one user. Consequently, the Role Playing Game (RPG) RPG Forum sub-module 230 enables users to showcase their creations related to the Role Playing Game (RPG) and RPG Forum creations.

In one embodiment of the present invention, the Role Playing Game (RPG) Forum rating and scoring sub-module 235 provides means for rating virtual and real characters and incorporating comments from the viewers. The information on rating of characters with the positive ratings is stored in a database of fair players and is exhibited in the special domains (galleries) of fair players. In operation, the links to multimedia compositions related to the fair players, their domains (galleries), and other pertinent information are provided. The information on rating of characters with the negative ratings is stored in a database of unfair players and is exhibited in the special domains (galleries) of unfair players. However, the links to multimedia compositions related to the unfair players, their domains (galleries), and other pertinent information are provided. The Role Playing Game (RPG) and RPG Forum game rating and scoring sub-module 235 is configured to provide means to incorporate the multiple comments from the multiple users and means for assigning score to the multiple users based on multiple human behavior trait parameters. Further, the multiple human behavior traits include honesty trait, an intellect trait, a readiness to help trait and the like. Consequently, the Role Playing Game (RPG) Forum rating and scoring sub-module 235 is configured to cultivate positive, socially responsible behaviors and depict examples of negative and fair behaviors. The Role Playing Game (RPG) and RPG Forum game development sub-module 240 is configured to provide means for developing at least one new game by the at least one user. The plurality of RPG and RPG Forum based games including a plurality of virtual reality games, a plurality of real reality games, including, but not limited to a plurality of everyday life games, a plurality of invention games, a plurality of business games, a plurality of masquerade games, a plurality of sport and fantasy sport-like games, and the like. Consequently, the Role Playing Game (RPG) and RPG Forum game development sub-module 240 enables the users to develop their creations related to the RPG and RPG Forum games.

In one embodiment of the present invention, the multiple gaming parameters include multiple virtual weapons, a protection gear, multiple maps, and any other gaming environment parameters and elements including means for conducting multiple missions, multiple virtual battles, means to select, modify the multiple gaming parameters, means to change at least one game mode by the at least one user, means to incorporate multiple scenarios, and multiple algorithms for a character interaction.

FIG. 2H illustrates the Customization Module 32 of the system 100 for multimedia based learning in a computer-based environment, according to one embodiment of the present invention. The customization module 32 includes a first form customization sub-module 242, a first content customization sub-module 244, a second form customization sub-module 245, and a second content customization sub-module 247. The first form customization sub-module 242 is configured to provide means for authors to customize authoring tool and environment including, but not limited to background, layout, text font, and other elements according to the user preferences. The first content customization sub-module 244 is configured to provide means for authors to select and customize a set of resource databases, including multiple text, image, sound, and video-files according to the user preferences. The second form customization sub-module 245 is configured to provide means for viewers to customize viewing environment including, but not limited to background, layout, text font, and other elements according to the user preferences and the second content customization sub-module 247 is configured to provide means for viewers to select and customize text, image, sound, and video-files according to the user preferences. Consequently, the customization module 32 provides means for automatic customization of one or more parameters of the multimedia composition based on viewer input on preferred types of literature, music, art, videos, viewer's mood, background, text font, colour, and any other parameter of the multimedia compositions based on viewers input on preferences related to presentation form of the composition.

FIG. 2I illustrates the process module 248 of the system 100 for multimedia based learning in a computer-based environment, according to one embodiment of the present invention. The process module 33 includes an image processing sub-module 248, a sound processing sub-module 249, a video-file processing sub-module 250, a text processing sub-module 251, and a combination sub-module 252. The image processing sub-module 248 is configured to provide means for at least one of an image enhancement, manipulation, distortion, and any other operations with multiple images. The sound processing sub-module 249 is configured to provide means for at least one of a sound enhancement, manipulation, distortion, and any other operations with multiple sounds. The video-file processing sub-module 250 is configured to provide means for at least one of a video-file enhancement, manipulation, distortion, and any other operations with multiple video-files. The text processing sub-module 251 providing means for manipulation, distortion, and other operations with a multiple text files and the combination sub-module 252 configured to combine at least one of the multiple image files, the multiple sound files, the multiple video files and the multiple text files in layers, provide means for writing between multiple lines, hiding text, the multiple image files, the multiple sound files, and the multiple video files and activate at least one of control between the multiple lines, behind the multiple text files, and the multiple image files and the means for processing include modification, combination, manipulation of the at least one of the multiple image files, the multiple sound files, the multiple video files and the multiple text files and spell-check and grammar analysis of the multiple text files. Consequently, the process module 33 enables users to manipulate image, audio, video, and text-files as a part of a reality game and present the results in a form of a hiding game, in which players find hidden images, text, or any other type of information.

FIG. 2J illustrates the Simulation Module 34 of the system 100 for multimedia based learning in a computer-based environment, according to one embodiment of the present invention. The simulation module 34 includes a user behaviour analysis sub-module 254, a matching sub-module 256 and an artificial intelligence sub-module 258. The user behaviour analysis sub-module 254 configured to analyse at least one user's behavior based on multiple user's input means. Particularly, the multiple user's input means includes a user's input to multiple forms, feedback to questions posted along with multimedia compositions, a mouse control and scroll, a web page loading, selecting at least one link from the multiple databases, multiple computer interaction habits of the at least one user, a multiple user selection of color scheme, font, preferred types of text, music, image, and video-files, at least one rating of the at least one user composition, at least one comment, at least one collaboration habit and the like. Consequently, the user behaviour analysis sub-module 254 enables the users to learn their psychological profile and preferences and optimize the on-line gaming experience.

In operation, the matching sub-module 256 is configured to match at least two users with at least one of a similar behavior, opposite values, experience, any specified parameters of habits, multiple preferences of the multiple users and the like. Consequently, the matching sub-module 256 enables the users looking for partners to show their creations, explain their life experiences by referring to the Life Road, or Book of Life, a digital story written in a format of a Blog-Book-Game, share family tree files, and the like. The artificial intelligence sub-module 258 is configured to mimic human behavior in playing against at least one computer means. Further, the artificial intelligence sub-module 258 provides user pieces of the user's computer version of the Everyday Life Game in a specified order defined by the user or by the artificial intelligence sub-module 258. Consequently, the artificial intelligence sub-module 258 provides users to conduct the Everyday Life Game according to one or more mechanisms of generating a sequence of life events of the user including random, most optimized, and any other algorithm. Further, the artificial intelligence sub-module 258 is linked to the user behavior analysis sub-module 254 and enables optimization of the sequence of life events of the user based on the psychological, ethnical, educational, and any other profiles characterizing personal qualities of the user. In one embodiment of the present invention, the pieces of the user's Everyday Life Game are presented at random.

In yet another embodiment of the present invention, the pieces of the user's Everyday Life Game are presented to the user in the most optimized way for the user, with the optimization criteria including development of strong will, honesty, intellectual capabilities, and other positive traits and characteristics. Particularly, the user develops the storyline generated by the artificial intelligence sub-module 258 according to a specified algorithm by adding text, image, audio, and video-components based on the user life experience or fictional experiences.

FIG. 2K illustrates the control module 36 of the system 100 for multimedia based learning in a computer-based environment, according to one embodiment of the present invention. The control module 36 includes a content control sub-module 260, a user behaviour control sub-module 262, a reference control sub-module 264, and a parental control sub-module 266. The content control sub-module 260 is configured to retrieve at least one multimedia composition with an inappropriate content stored in the first database 52 by the at least one user and control multiple multimedia compositions constituting plagiarism, by executing a set of instructions to remove and/or modify the at least one multimedia composition stored in the first database 52. Particularly, the inappropriate content includes a derogatory language, a hatred language and any other inappropriate language. The user behavior control sub-module 262 is configured to identify at least one negative comment. Particularly, the at least one multimedia composition constituting at least one of cyber bulling, an unauthorized use of an original material, a proprietary idea, any other proprietary intellectual property stored in the first database 52 and the second database 42, executing a set of instructions to remove the at least one negative comment and the at least one multimedia composition from the multiple databases, executing a set of instructions to formulate at least one adjustment to at least one user's score, and generate information about at least one unfair and inappropriate action of the at least one user. Moreover, the user behaviour control sub-module 262 provides for identifying positive multimedia compositions and comments with the highest rating, users with the high score, users winning competitions and other users with a distinguished record of community service, collegial behaviour, learning, and creativity and posting information about the users in a special domain providing information about positive user behaviour and examples of their multimedia compositions. The reference control sub-module 262 is configured to generate a behavior information about the at least one of the user and organization exhibiting positive behavior or negative behavior on the interface of the at least one client device 65 and executing a set of instructions to rate nominees based on feedback received from the multiple users and store in the at least one database of the multiple databases. The parental control sub-module 266 is configured to provide means for parents to receive information about their child's rating, grades, financial rewards and the like retrieved from the multiple databases of the present invention. Consequently, the control module 36 enables users control the content posted in the users created domains (galleries). Moreover, the control module 36 encourages positive user actions by posting information about users helping to enforce rules of conduct in galleries of unfair players. Furthermore, the control module 36 rewards users helping to control the posted content and user behavior by reporting inappropriate content and user behavior. The users reporting inappropriate content and user behavior earn community service points and advance in the digital police fraternity or e-police guild, or any other user organization. Subsequently, pay rate associated with the advertising and sponsor links of users reporting inappropriate content and user behavior increases. Further, the control module 36 discourages negative user actions by posting information about users violating rules of conduct in galleries of unfair players.

FIG. 2L illustrates the conflict resolution Module 38 of the system 100 for multimedia based learning in a computer-based environment, according to one embodiment of the present invention. The conflict resolution module 38 includes a submission sub-module 268 configured to store multiple forms or information of the multiple forms to a conflict resolution center database and a resolution processing sub-module 270 configured to generate analysis of the multiple forms stored in the conflict resolution center database, by retrieving a multiple opinions, voting and rating of the multiple users from at least one database of the multiple databases, and generate at least one conflict resolution solution to the at least one user via the interface. The present invention provides resolving issues directly related to the educational gaming system, and also for other questions as well.

In one embodiment of the present invention, the conflict resolution module 38 has a set of instructions to track response to users' requests submitted to government officials, public organization administrators, private and public companies, and any other organization. Further, a copy of a letter, e-mail message, or any other document sent by a user is stored in the database, which is accessed by other users for viewing, commenting, rating, and any other actions allowed by the user. The conflict resolution module 38 has a set of instructions to track time for receiving response to the user submitted inquiry and enables the user to post the response received along with the original inquiry, as well as commenting and grading by viewers and exhibiting the score of the comments and the score for the respondent to the viewers according to the preferences chosen by the user. Further, linking the conflict resolution module 38 with the gaming module 30 enables users to create multimedia compositions related to their inquiries, response received (or not received), and incorporate them as a part of the reality game. Further, the system 100 includes an optimization module 39 configured to engage multiple senior users in a multiple cognitive exercise by providing multiple resources. Particularly, engage the multiple senior users in learning ancestry, engage multiple corporate users in learning multiple skills by providing multiple corporate resources for creating the multiple multimedia compositions on the multiple subjects, and engage multiple young users in learning at least one of fields includes reading, arts, music, and the like. The optimization module 39 has a set of instructions to collaborate with a family members, multiple peers, and caregivers. Particularly, the multiple resources includes a music therapy, an art therapy, a poetry therapy, a dance therapy, and any other expressive therapies and collaborate with the family members, the peers, and the multiple caregivers, and the skills includes a safety skill, an innovation skill, multiple language skills, and multiple professional skills and the system 100 is further configured to execute a set of instructions to determine the at least one user with at least one of similar interest, preference, experience, with multiple desirable set of personality traits, social status, ethnical background, or any other desirable personal characteristics.

Embodiment of the present invention provides, a method for multimedia based educational game learning for multiple users, includes the steps of creating multiple multimedia compositions by at least one user, and executing a set of instructions to combine at least one link selected from a text, an image, an audio, and a video based link to the multiple multimedia compositions, retrieving the at least one user information from multiple databases 42,44,46,48,50, tracking progress of the multiple users, and managing multiple user groups and multiple user domains and facilitating an user collaboration on at least one level, conducting at least one competition for a best multimedia composition and determining at least one partner and at least one sponsor for the at least one competition, facilitating at least one rating by the multiple users of an entire composition, and at least one of component and sub-components of the multimedia composition.

In one embodiment of the present invention, the at least one of component and sub-components include at least one part of text, image, audio, and video-files according to multiple criteria parameters.

In one embodiment of the present invention, the method further includes the steps of executing a set of instructions to rate multiple comments of the multiple users and multiple juries, providing the multiple users as a reward at least one of a part of advertising, multiple sponsor links, multiple licensing revenues, and multiple competition prizes, providing the multiple users with multiple commerce capabilities and means for forming at least one of cooperatives, franchises, and means for evaluating and paying tax, combining at least one of multiple entertainment and educational games, multiple physical games, multiple role playing games (RPG) and multiple RPG Forum games, providing at least one of a customized content and a form according to at least one author preferences and at least one user preferences, processing at least one of a digital image, an audio, a video, and multiple text files to achieve at least one desirable effect, analysing user behavior based on user-computer interaction and a multiple user preferences, determining the multiple users with a desirable set of personality trait parameters, and to simulate human behavior, processing multiple online forms with multiple user comments and complains, analysing at least one user's behavior based on multiple user's input means. Further, the multiple users' input means includes a user's input to multiple forms, a mouse control and scroll, and a web page loading.

In one embodiment of the present invention, the method further includes the steps of selecting at least one link from the multiple databases 46,56, multiple computer interaction habits of the at least one user, multiple user selection of color scheme, font, preferred types of text, music, image, and video-files, at least one rating of the at least one user composition, at least one comment, at least one collaboration habit and the like, matching at least two users with at least one of a similar behavior, opposite values, experience, any specified parameters of habits, multiple preferences of the multiple users and the like and mimicking human behavior in playing against at least one computer means. Particularly, the multiple criteria parameters include content and presentation form, and grading by multiple instructors.

In one embodiment of the present invention, the method further includes the steps of providing means for displaying multiple user created compositions in public or private password protected galleries and sub-galleries hierarchally arranged for multiple topics within at least one gallery related to a same field or subject, executing a set of instructions to perform at least one of a keyword searching, filtering the at least one multimedia composition on at least one of a subject and a topic, determining at least one mentor and at least one consultant for at least one individual user and/or at least one team, determining multiple user friends ready to offer help by retrieving information about the multiple user friends from the multiple databases 52. Further, retrieving at least one data from the multiple databases, wherein the multiple databases include at least one of text, image, audio, video-files, multiple links to multiple online resources, multiple tutorials on creation of online multimedia compositions, and multiple teaching courses for multiple fields and multiple topics includes a teaching data and a testing data, interacting with the multiple friends by using at least one interaction platform and managing the multiple user groups. Particularly, providing at least one user authentication, and executing a set of instructions to create multiple user accounts, tracking a user progress for the multiple users from at least one common organization according to multiple parameters. The multiple parameters includes a class, a grade, an organization department, multiple users names, rating of the multiple multimedia compositions, grading by multiple teachers, multiple links to the multiple multimedia compositions, multiple comments, and the like.

Further, dividing a group or organizational users in multiple teams by executing multiple algorithms, executing at least one a set of instructions to provide at least one of a random selection, a specified group size, an alphabetical order of multiple user names, and the like, providing means to the user to invite at least one other user on a team and manage the team, enabling multiple authorized users to create, modify or remove at least one sub-domain within at least one authorized user domain wherein, the at least one sub-domain includes at least one of multiple galleries for multiple subjects, at least one gallery for at least one topic and a project, multiple family galleries with at least one information resource, and multiple showcase multimedia compositions. In operation, retrieving at least one multimedia composition with an inappropriate content stored in the first database 52 by the at least one user and control multiple multimedia compositions constituting plagiarism, by executing a set of instructions to remove and/or modify the at least one multimedia composition stored in the first database, wherein the inappropriate content include a derogatory language, a hatred language and any other inappropriate language, identifying at least one negative comment, the at least one multimedia composition constituting at least one of cyber bulling, an unauthorized use of an original material, a proprietary idea, any other proprietary intellectual property stored in the first database 52 and the second database 42, executing a set of instructions to remove the at least one negative comment and the at least one multimedia composition from the multiple databases, executing a set of instructions to formulate at least one adjustment to at least one user's score, and generate information about at least one unfair and inappropriate action of the at least one user, generating a behavior information about the at least one of the user and organization exhibiting positive behavior or negative behavior on the interface of the at least one client device and executing a set of instructions to rate nominees based on feedback received from the multiple users and store in the at least one database of the multiple databases and providing means for parents to receive at least one information about their child's rating, grades, financial rewards and the like retrieved from the multiple databases 58.

In one embodiment of the present invention, the method further includes the steps of storing user information in the database 52, selecting one or more personal preferences for example font, colour, avatar, and other user specific information, creating multimedia compositions by the user or modifying existing compositions stored in the first database if allowed by original authors. Particularly, receiving financial rewards through posting advertisements and/or sponsor links on user's pages, receiving licensing fees for the original content, and competitions and requesting or offering help to improve the compositions. Moreover, using variety of online educational games and participating in a variety of RPG and RPG Forum games including, but not limited to Everyday Life Game, Honest Game, Invention Game, and other games related to users' everyday life.

In one embodiment of the present invention, the method further includes the steps of conducting multiple online competitions for selecting a best multimedia composition, create multiple rubrics and specify multiple judging criteria, inviting multiple judges to enter a score, determining multiple sponsors providing prizes in at least one form of monetary, product, a plurality of discount coupons, scholarship, and a plurality of rewards, and add sponsor links to the user created compositions, determining multiple partners and challenge at least one competitor team, determining multiple mentors and multiple consultants providing expert opinion and help with creating the multiple multimedia compositions, executing a set of instructions to share the at least one multimedia composition information in a real time and create at least one new multimedia composition by the at least one user, contacting the multiple users based on at least one share parameter to rate at least one of the multiple user's original multimedia compositions, and multiple users modified multimedia compositions proposed by the multiple users in real time, retrieving information about the multiple users determined as at least one friend from the user database and the at least one share parameter includes the multiple users sharing at least one topic of interest and the like, enabling multiple user interactions through chat, bulletin boards, and the like, providing at least one of multiple entertaining games and multiple links to the multiple entertaining games, retrieved from a physical game database. Further, providing means for building a virtual environment or customizing a user's gallery according to the multiple user's preferences, providing means for generating multiple virtual characters, and executing a set of instructions to provide means to retrieve at least one RPG character from the avatar database 44, weapons, tools, and other gaming items, character traits, power, and the like, providing means to keep track of the multiple user created multimedia compositions, rating of the user created multimedia compositions, multiple views and the user's progress through multiple ranks according to a specified algorithm considering the rating and the multiple views of user created multimedia compositions and community service points received for posting links of non-profit organizations, reporting at least one inappropriate content, and performing other community useful actions, providing means for creating at least guild, multiple professional societies and the like, providing means for developing a common thread and multiple alternative threads by incorporating at least one of the multiple images, the multiple sound, the multiple video-files, multiple related real life events, multiple fictional action events, and means to incorporate the multiple scenarios, multiple templates includes at least one template for developing a thread from at least one of a first person perspective, a second person perspective, and a third-person perspective, and multiple RPG Forum based format includes at least one story written by the at least one user.

In one embodiment of the present invention, the physical game database includes at least one of a physical game, a football game, a baseball game, a soccer game, and the like.

In one embodiment of the present invention, the method further includes the steps of providing means for rating at least one of multiple virtual characters and multiple real characters, means to incorporate the multiple comments from the multiple users and means for assigning score to the multiple users based on multiple human behavior trait parameters, the multiple human behavior traits include a honesty trait, an intellect trait, a readiness to help trait and the like, providing multiple virtual galleries for exhibiting user created multimedia compositions related to the RPG and RPG Forum games includes everyday life games, multiple invention games, multiple business games, multiple masquerade games, multiple fantasy sport-like games, multiple fair players gallery, multiple unfair players gallery and the like. The method further includes the steps of providing means for developing at least one new game by the at least one user, the multiple RPG and RPG Forum based games includes multiple virtual reality games, multiple real reality games, multiple everyday life games, the multiple invention games, the multiple business games, the multiple masquerade games, the multiple fantasy sport-like games, and the like, and managing a blog information of at least one of multiple real societies, multiple virtual societies, multiple guilds and multiple organizations.

In one embodiment of the present invention, the method further includes the steps of creating multiple advertisements and multiple sponsor banners, combining multiple media, storing at least one of multiple existing advertisements and multiple sponsor banners in at least one link database includes multiple advertisement links and multiple sponsor banners, adding the multiple advertisement links and/or the multiple sponsor links to the at least one link database determined by at least one users' rank and membership level, accessing the at least one link database determined by the users' rank and membership level, selecting the multiple advertisement links retrieved from the at least one link database determined by the users' rank and membership level, providing at least one link selected from the multiple advertisement links and/or the multiple sponsor links on the interface of the at least one client device along with the user's multimedia composition in a user defined location and a user defined format with a preference of the user defined location and user defined format determined by the users' rank and membership level, evaluating corresponding reward made to the multiple users in a form of at least one reward according to at least one of a specified algorithm and multiple second reward parameters and rating of the multiple multimedia compositions, providing license to at least one user of at least one user's original text, audio, image, video-file and/or multimedia composition stored in the resource database 50 for a specified payment gateway with a licensing fees determined by at least one of a fixed price, a percent of total revenues generated through the multiple advertising links and the multiple sponsor links posted along with the multimedia composition utilizing the original material, providing means for the at least one user and multiple viewers to customize at least one authoring tool for viewing environment, wherein the at least one authoring tool is selected from a background tool, a layout tool, a text font tool, and the like according to the multiple user preferences, providing means for the at least one user to select and customize multiple text, image, sound, and video-files according to the multiple user preferences by retrieving information from the resource database 50, providing means for at least one of an image enhancement, manipulation, distortion, and any other operations with the multiple images, providing means for at least one of a sound enhancement, manipulation, distortion, and any other operations with multiple sounds, providing means for at least one of a video-file enhancement, manipulation, distortion, and any other operations with multiple video-files, providing means for manipulation, distortion, and other operations with multiple text files.

Further, the method includes the steps of combining at least one of the multiple image files, the multiple sound files, the multiple video files and the multiple text files in layers, providing means for writing between multiple lines, hiding text, the multiple image files, the multiple sound files, and the multiple video files and activate at least one of control between the multiple lines, behind the multiple text files, and the multiple image files and the means for processing include modification, combination, manipulation of the at least one of the multiple image files, the multiple sound files, the multiple video files and the multiple text files and spell-check and grammar analysis of the multiple text files, storing multiple forms or information of the multiple forms in a conflict resolution center database and generating analysis of the multiple forms stored in the conflict resolution center database, by retrieving multiple opinions, voting and rating of the multiple users from at least one database of the multiple databases, and generate at least one conflict resolution solution to the at least one user via the interface.

In one embodiment of the present invention, the method further includes the steps of conducting multiple transactions on an interface of at least one client device includes the steps of enabling the multiple users to sell multiple products or buy the multiple products, conducting multiple transactions over the communication network where the multiple products that the at least one user post for sell depends on the user's gaming score and type of membership, forming multiple cooperatives includes at least one of multiple creative cooperatives, multiple consulting cooperatives, multiple educational cooperatives and the like, the multiple creative cooperatives includes at least one of multiple cooperatives producing art, music, literature and the like, the multiple consulting cooperatives includes at least one of multiple cooperatives providing technical consulting services for technical design, solution of technical problems, any other type of technical services and the like and the multiple educational cooperatives includes at least one of multiple cooperatives providing tutoring services in multiple fields includes science, art, physical fitness, professional skills and the like, providing means to create, manage, and conduct at least one transaction in multiple user formed franchises, the multiple user formed franchises include multiple educational franchises, multiple creative franchises and the like and providing means for generating multiple online user accounts, managing the multiple online user accounts, maintaining the multiple user's personal information, conducting at least one transaction to pay for a membership fee, evaluating tax and providing tax related information to the multiple users and transferring funds in and from the multiple online user accounts.

In one embodiment of the present invention, the method further includes the steps of engaging multiple senior users in multiple cognitive exercises by providing multiple resources and engaging the multiple senior users in learning ancestry, engaging multiple corporate users in learning multiple skills by providing multiple corporate resources for creating the multiple multimedia compositions on the multiple subjects and collaborate the multiple corporate users with multiple family members, multiple peers, and multiple caregivers, engaging multiple young users in learning at least one of fields includes reading, arts, music, and the like and collaborate with the multiple family members, the multiple peers, and the multiple caregivers, determining at least two users with at least one of similar interest, a preference, an experience, a multiple desirable personality traits, a social status, an ethnical background, or any other desirable personal characteristic. Further, the multiple corporate resources include at least one therapy selected from a music therapy, an art therapy, a poetry therapy, a dance therapy, and any other expressive therapies and the multiple skills includes a safety skill, an innovation skill, a multiple language skills, and a multiple professional skills.

In one embodiment of the present invention, the at least one level includes an individual level and a team level, the at least one interaction platform includes a chat, a discussion forum, a second and any other type of user interaction platform, and the multiple second reward parameters include advertising, multiple sponsor links, number of views and composition rating, multiple licensing fees, and community service including, but not limited to reporting multimedia compositions with an inappropriate content, multiple posted links of non-profit organizations or their donors and sponsors, and multiple multimedia compositions promoting social cause and the at least one reward includes a monetary reward, a non-monetary reward, a scholarship, multiple bonds, multiple product discounts and the like.

In another embodiment of the present invention, the method is used for creating digital greeting cards. The users create rich media compositions and send links electronically to other users. The present invention provides templates for multimedia greeting cards for special occasions, including, but not limited to birthdays, weddings, graduations, and other life events, Holidays, and any other type of greeting cards. Further, the system is used for digital scrap booking. The system provides templates for digital scrapbook albums. Particularly, the albums are organized for various topics including, but not limited to farm life, flower collection, and any other topic. Moreover, the system is used for digital photo albums creation. The system provides templates for digital photo albums. The albums are organized for various topics including, but not limited to family vacations, visited museums, and other topics. The present system is further used to re-cycle (re-use) old movie segments, unused movie segments (scenes that did not make the final cut), old music, old book segments, and any other information in any format.

In yet another embodiment of the present invention, the method includes steps to provide cognitive exercises to maintain cognitive reserve. Particularly, the senior users create multimedia compositions as a part of recreational activities, post them on the Internet, interact with other users, including their family members and/or caregivers, and receive financial rewards according to the novel financial reward mechanisms. The databases of images, audio, text, and video-files provided enable combining art therapy, music therapy, poetry therapy and other expressive therapies.

In yet another embodiment of the present invention, the method includes steps to create family trees. The multimedia compositions created by family members are linked by the various modules of the present invention.

In yet another embodiment of the present invention, the system 100 is used for engaging corporate users in learning safety, innovation, languages, and professional skills by providing resources for creating multimedia compositions on said subjects, interaction by using on-line video streaming, pen-pal correspondence, or any other ways of user communication. Further, the system 100 is optimized for conducting safety audits online by accessing corporate safety galleries, individual employee's domains and viewing their safety related multimedia compositions. Further, the system is optimized for engaging employees in learning safety and cultivating safety culture by conducting competitions for the best multimedia compositions on safety created by the employees.

In yet another embodiment of the present invention, the system 100 is used to provide users with information about their psychological profile. The system provides a set of forms, questionnaires, responses and user behaviour analysing programs providing users with information about their psychological profile. The present invention provides the user to find users with similar or different psychological profile. Furthermore, the system 100 enable users to play the Honest Game honestly, and other behavioural games in a way corresponding to high social values, rating the games and the players, and rewarding socially responsible behaviour.

Therefore, as may be seen, various embodiments of the present invention provide multiple advantages over prior art, such as, for example, but not limited to, payment of licensing fees to users, helpful comments and suggestions for improving other users' compositions as rated by the original authors and/or jury, and the like. The present invention provides the users to exhibit their work in public (open) or private (password protected) online galleries, customize the appearance and content of the galleries, share common resources, incorporate elements of Role Playing Games (RPG) and RPG Forums, promote the galleries via electronic advertisements or using a paid membership structure enabling premium services, and perform other important functions to attract viewers. Moreover, the present invention provides rating and grading of the multimedia composition in its entirety, its individual components and sub-components, including, but not limited to poetry lines and words, music parts, parts of images and videos. Further, present invention enables custom design of grading criteria in the rubrics. The present invention provides financial incentives for users to engage in learning, collaboration, and resource sharing. Further, The Universal Score, which is also considered in calculating said user's financial rewards, bridges fun and educational games. The multiple parameters of the present invention for tracking user's progress in gaming activities include one or more games, rating of user's RPG and RPG Forum creations, the Universal Score, user's game level, e.g. apprentice, master, grand-master, and alike, and other pertinent information. The present invention provides a flexible user management sub-module for forming groups of both individual and organizational users according to one or more parameters. The domain management sub-module provides multiple benefits to the users, including, but not limited to, creation of personal galleries, family galleries, organizations' galleries, that is password protected or public with their own information resources, showcasing multimedia compositions, and the like. Particularly, the present invention enables the users to create digital portfolios of their work and databases of resource materials. The present invention encourages user collaboration enabling users offering improvements to the original compositions to financially benefit from posting advertising and sponsor links along with the modified composition, and authors from receiving a part of said advertising and sponsor links revenues generated by the said modified composition. The present invention provides a novel sponsor sub-module to engage users in learning and creative activities and provide online advertising to sponsors. The present invention provides a set of instructions to engage users in learning and creative activities through collaboration as partners or competitors, collaboration between users, mentors and consultants to help users to create better multimedia compositions, better learn and create, as well as promote their creations based on recommendations of recognized experts in the field.

The present invention further provides a simplified development of compositions by allowing users offer or find help, facilitating user collaboration by allowing users to start new user groups, and the like. The present invention provides business related services with gaming elements. Particularly, the present invention provides a method for multimedia based learning in a computer-based gaming environment combining elements of project oriented learning, educational gaming, and financial rewards enhancing engagement in learning, collegial behaviors, and user collaboration.

In the foregoing specification, specific embodiments of the present invention have been described. However, one of ordinary skill in the art will appreciate that various modifications and changes can be made without departing from the spirit and scope of the present invention as set forth in the various embodiments discussed above. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements as described herein.

1. A system for multimedia based educational game learning for a plurality of users, said system comprising:
a central processing unit, a set of support circuits and at least one server computer for communicating over a communication network, said server comprising:
at least one processor configured to execute at least one set of instructions for multimedia based educational game learning;
a memory device coupled to said at least one processor, said memory device comprising a plurality of modules configured to provide an interactive learning environment to said plurality of users via said communication network and a plurality of databases, having stored therein said at least one set of instructions for execution by said at least one processor; and
an interface to provide access to said server from a plurality of client devices over said communication network;
wherein said plurality of modules comprise a content management module configured to provide a plurality of learning resources, means for creating a plurality of online multimedia compositions, showcasing and rating of at least one of said plurality of online multimedia compositions and at least one portion of said plurality of online multimedia compositions; a user management module configured to retrieve an user information from said plurality of databases, track progress of said plurality of users, and manage a plurality of user groups and a plurality of user domains; a collaboration management module configured to facilitate user collaboration on at least one level, said at least one level comprising an individual level and a team level, conduct at least one competition for a best multimedia composition, determining at least one partner and at least one sponsor for said at least one competition, and determining at least one mentor and at least one consultant for at least one individual user and at least one team; a social interaction management module configured to determine a plurality of user friends ready to offer help by retrieving information about said plurality of user friends from said plurality of databases, interact with said plurality of friends by using at least one interaction platform, said at least one interaction platform comprising a chat, a discussion forum, any other type of user interaction platform, and managing said plurality of user groups; a reward module configured to provide said plurality of users as a reward at least one of a part of advertising, a plurality of sponsor links, a plurality of licensing revenues, and a plurality of competition prizes; a commerce module configured to provide said plurality of users with a plurality of commerce capabilities and means for forming at least one of cooperatives, franchises, and means for evaluating and paying tax; a role playing gaming module configured to combine at least one of a plurality of entertainment and educational games, a plurality of physical games, a plurality of role playing games (RPG) and a plurality of RPG Forum games; a customization module configured to provide at least one of a customized content and a form according to at least one author preferences and at least one user preferences; a tools and utilities module configured to process at least one of a digital image, an audio, a video, and a plurality of text files to achieve at least one desirable effect; an artificial intelligence simulation module configured to analyze user behavior based on user-computer interaction and a plurality of user preferences, determine said plurality of users with a desirable set of personality trait parameters, and to simulate human behavior; a control module configured to control content, plagiarism, cyber bulling, and other negative behaviors and encourage collegial user interaction and other positive behaviors; and a conflict resolution module configured to process a plurality of online forms with a plurality of user comments and complains.

2. The system of claim 1, wherein said content management module comprises:
a resource sub-module retrieving at least one data from said plurality of databases, wherein said plurality of databases comprise at least one of text, image, audio, video-files, including relational databases, a plurality of links to a plurality of online resources, a plurality of tutorials on creation of online multimedia compositions, and a plurality of teaching courses for a plurality of fields and a plurality of topics comprising a teaching data and a testing data;
a creation and execution sub-module configured to create said plurality of multimedia compositions by said at least one user, and executing a set of instructions to combine said at least one of text, image, audio, or video-file or links to said plurality of files;
a showcasing sub-module providing means for displaying user created compositions in public or private password protected galleries and sub-galleries hierarchically arranged for a plurality of topics within at least one gallery related to a same field or subject;
an organization sub-module configured to organize relevant data by subjects, topics and the like and executing a set of instructions to perform at least one of a keyword searching, filtering said at least one multimedia composition on at least one of a subject and a topic; and
a rating sub-module configured to facilitate at least one of rating by said plurality of users, an entire composition, at least one of components and sub-components of said composition, wherein said at least one of components and sub-components comprise at least one part of text, image, audio, and video-files according to a plurality of criteria parameters, executing a set of instructions to rate a plurality of comments of said plurality of users and a plurality of juries, wherein said plurality of criteria parameters comprise content and presentation form, and grading by a plurality of instructors.

3. The system of claim 1, wherein said user management module comprises:
a user information sub-module configured to provide at least one user authentication, and executing a set of instructions to create a plurality of user accounts;
a tracking sub-module configured to track a user progress for said plurality of users from at least one common organization according to a plurality of parameters, said plurality of parameters comprising a class, a grade, an organization department, a plurality of users names, rating of said plurality of multimedia compositions, grading by a plurality of teachers, a plurality of links to said plurality of multimedia compositions, a plurality of comments, and the like;
a management sub-module configured to divide a group or organizational users in a plurality of teams by executing a plurality of algorithms, executing at least one a set of instructions to provide at least one of a random selection, a specified group size, an alphabetical order of a plurality of user names, and the like;
a user created team management sub-module configured to provide means to said user to invite at least one other user on a team and manage said team; and
a domain management sub-module configured to enable a plurality of authorized users to create, modify or remove at least one sub-domain within at least one authorized user domain wherein, said at least one sub-domain comprises at least one of a plurality of galleries for a plurality of subjects, at least one gallery for at least one topic and a project, a plurality of family galleries with at least one information resource, and a plurality of showcase multimedia compositions.

4. The system of claim 1, wherein said collaboration management module comprises:
a first management sub-module configured to manage collaboration of a same composition on at least one of an individual level and a team level;
a second management competition sub-module configured to conduct a plurality of online competitions for selecting a best multimedia composition, create rubrics and specify a plurality of judging criteria, invite a plurality of judges and enter a score;
a competition sponsor sub-module configured to determine a plurality of sponsors providing prizes in at least one form of monetary, product, discount coupons, scholarship, and a plurality of rewards, and add sponsor links to said user created compositions;
a competition partner sub-module configured to determine a plurality of partners and challenge at least one competitor team; and
a recommending sub-module configured to determine a plurality of mentors and a plurality of consultants providing expert opinion and help with creating said plurality of multimedia compositions.

5. The system of claim 1, wherein said social interaction management module comprises:
a contact sub-module configured to contact said plurality of users determined as friends, execute a set of instruction to share said at least one multimedia composition information in a real time and create at least one new multimedia composition by said friends, contact said plurality of users based on at least one share parameter to rate at least one of said plurality of user's original multimedia compositions, and a plurality of users modified multimedia compositions proposed by said plurality of users in real time, wherein said contact sub-module retrieves information about said plurality of users determined as said at least one friend from said user database and said at least one share parameter comprises said plurality of users sharing at least one topic of interest and the like;
a linking sub-module configured to at least link and cross link said at least one multimedia composition, and any other posted information;
a user exchange information sub-module for user contacts configured to enable a plurality of user interactions through chat, bulletin boards, and alike; and
a blog information managing sub-module configured to manage a blog information of at least one of a plurality of real societies, a plurality of virtual societies, a plurality of guilds and a plurality of organizations.

6. The system of claim 1, wherein said reward module comprises at least one of an advertisement sub-module and a sponsor link sub-module each configured to enable said plurality of users to conduct at least one of following steps:
creating a plurality of advertisements and a plurality of sponsor banners, combining a plurality of media, storing at least one of a plurality of existing advertisements and a plurality of sponsor banners in at least one link database comprising a plurality of advertisement links and a plurality of sponsor banners;
adding said plurality of advertisement links and/or said plurality of sponsor links to said at least one link database determined by at least one users' rank and membership level;
accessing said at least one link database determined by said users' rank and membership level;
selecting said plurality of advertisement links retrieved from said at least one link database determined by said users' rank and membership level;
providing at least one link selected from said plurality of advertisement links and/or said plurality of sponsor links on said interface of said at least one client device along with said user's multimedia composition in a user defined location and a user defined format with a preference of said user defined location and user defined format determined by said users' rank and membership level;
said reward module further comprises a reward evaluation sub-module configured to evaluate corresponding reward made to said plurality of users in a form of at least one reward according to at least one of a specified algorithm and a plurality of second reward parameters and rating of said plurality of multimedia compositions, wherein said plurality of second reward parameters comprise advertising, a plurality of sponsor links, number of views and composition rating, a plurality of licensing fees, and community service including, but not limited to reporting multimedia compositions with an inappropriate content, a plurality of posted links of non-profit organizations or their donors and sponsors, a plurality of multimedia compositions promoting social cause, and an overall team score in a case of organizational users; a modification sub-module is configured to add, modify said at least one sponsor links retrieved from a resource database; a licensing sub-module being configured to provide license to at least one user of at least one user's original text, audio, image, video-file and/or multimedia composition stored in said resource database for a specified payment gateway with a licensing fees determined by at least one of a fixed price, a percent of total revenues generated through said plurality of advertising links and said plurality of sponsor links posted along with said multimedia composition utilizing said original material; a competition sub-module configured to determine and provide competition prizes; and a reward distribution sub-module configured to distribute reward to said plurality of users with said at least one reward comprising a monetary reward, a non-monetary reward, a scholarship, a plurality of bonds, a plurality of product discounts and the like.

7. The system of claim 1, wherein said commerce module is configured to conduct a plurality of transactions on said interface of said at least one client device, said commerce module comprising:
an online store sub-module configured to enable said plurality of users to sell a plurality of products or buy said plurality of products, conducting a plurality of transactions over said communication network where said plurality of products that said at least one user post for sell depends on said user's gaming score and type of membership;
a cooperative sub-module configured to form a plurality of cooperatives comprising at least one of a plurality of creative cooperatives, a plurality of consulting cooperatives, a plurality of educational cooperatives and the like, said plurality of creative cooperatives comprising at least one of a plurality of cooperatives producing art, music, literature and the like, said plurality of consulting cooperatives comprising at least one of a plurality of cooperatives providing technical consulting services for technical design, solution of technical problems, any other type of technical services and the like and said plurality of educational cooperatives comprising at least one of a plurality of cooperatives providing tutoring services in a plurality of fields comprising science, art, physical fitness, professional skills and the like;
a user franchise sub-module configured to provide means to create, manage, and conduct at least one transaction in a plurality of user formed franchises, said plurality of user formed franchises comprise a plurality of educational franchises, a plurality of creative franchises and the like; and
an account management sub-module configured to provide means for generating a plurality of online user accounts, managing said plurality of online user accounts, maintaining said plurality of user's personal information, conducting at least one transaction to pay for a membership fee, evaluating tax and providing tax related information to said plurality of users and transferring funds in and from said plurality of online user accounts.

8. The system of claim 1, wherein said gaming module comprises:
an entertaining game sub-module configured to provide at least one of a plurality of entertaining games and a plurality of links to said plurality of entertaining games;
a physical game sub-module configured to provide a plurality of links to a plurality of physical games retrieved from a physical game database, said physical game database comprising at least one of a physical game, a football game, a baseball game, a soccer game, and the like;
a SIMs sub-module configured to provide means for building a virtual environment or customizing a user's gallery according to said user's preferences;
a character generation sub-module providing means for generating virtual characters, including but not limited to executing a set of instructions to provide means to retrieve at least one RPG character from said avatar database, weapons, tools, and other gaming items, character traits, power, and the like;
a progress tracking sub-module providing means to keep track of user created multimedia compositions, rating of said user created multimedia compositions, a plurality of views and said user's progress through a plurality of ranks according to a specified algorithm considering said rating and said plurality of views of user created multimedia compositions and community service points received for posting links of non-profit organizations, reporting inappropriate content, and performing other community useful actions;
a RPG sub-module providing means for creating guilds, professional societies and the like, a plurality of gaming parameters comprising a plurality of virtual weapons, a protection gear, a plurality of maps, and any other gaming environment parameters and elements comprising means for conducting a plurality of missions, a plurality of virtual battles, means to select, modify said plurality of gaming parameters, means to change at least one game mode by said at least one user, means to incorporate a plurality of scenarios, and a plurality of algorithms for a character interaction;
a Role Playing Game (RPG) Forum sub-module providing means for developing a common thread and a plurality of alternative threads by incorporating at least one of said plurality of images, said plurality of sound, said plurality of video-files, a plurality of related real life events, a plurality of fictional action events, and means to incorporate said plurality of scenarios, a plurality of templates comprising at least one template for developing thread from at least one of a first person perspective, a second person perspective, and a third-person perspective, and a plurality of RPG Forum based format comprising at least one story written by said at least one user;
a Role Playing Game (RPG) and RPG Forum game rating and scoring sub-module configured to provide means for rating at least one of a plurality of virtual characters and a plurality of real characters, means to incorporate said plurality of comments from said plurality of users and means for assigning score to said plurality of users based on a plurality of human behavior trait parameters, said plurality of human behavior traits comprise a honesty trait, an intellect trait, a readiness to help trait and the like;
a Role Playing Game (RPG) and RPG Forum game sub-module providing a plurality of virtual galleries for exhibiting user created multimedia compositions related to said RPG and RPG Forum games comprising everyday life games, a plurality of invention games, a plurality of business games, a plurality of masquerade games, a plurality of fantasy sport-like games, a plurality of fair players gallery, a plurality of unfair players gallery and the like; and
a Role Playing Game (RPG) and RPG Forum game development sub-module configured to provide means for developing at least one new game by said at least one user, said plurality of RPG and RPG Forum based games comprising a plurality of virtual reality games, a plurality of real reality games, a plurality of everyday life games, said plurality of invention games, said plurality of business games, said plurality of masquerade games, said plurality of fantasy sport-like games, and the like.

9. The system of claim 1, wherein said customization module comprises:
a first form customization sub-module configured to provide means for authors to customize authoring tool and environment including, but not limited to background, layout, text font, and other elements according to said user preferences;
a first content customization sub-module configured to provide means for authors to select and customize set of resource databases, including plurality of text, image, sound, and video-files according to said user preferences;
a second form customization sub-module configured to provide means for viewers to customize viewing environment including, but not limited to background, layout, text font, and other elements according to said user preferences; and
a second content customization sub-module configured to provide means for viewers to select and customize text, image, sound, and video-files according to said user preferences.

10. The system of claim 1, wherein said process module further comprises:
an image processing sub-module providing means for at least one of an image enhancement, manipulation, distortion, and any other operations with a plurality of images;
a sound processing sub-module providing means for at least one of a sound enhancement, manipulation, distortion, and any other operations with a plurality of sounds;
a video-file processing sub-module providing means for at least one of a video-file enhancement, manipulation, distortion, and any other operations with a plurality of video-files;
a text processing sub-module providing means for manipulation, distortion, and other operations with a plurality of text files; and
a combination sub-module configured to combine at least one of said plurality of image files, said plurality of sound files, said plurality of video files and said plurality of text files in layers, provide means for writing between a plurality of lines, hiding text, said plurality of image files, said plurality of sound files, and said plurality of video files and activate at least one of control between said plurality of lines, behind said plurality of text files, and said plurality of image files and said means for processing comprise modification, combination, manipulation of said at least one of said plurality of image files, said plurality of sound files, said plurality of video files and said plurality of text files and spell-check and grammar analysis of said plurality of text files.

11. The system of claim 1, wherein said simulation module comprises a user behavior analysis sub-module configured to analyze at least one user's behavior based on a plurality of user's input means, said plurality of user's input means comprising a user's input to a plurality of forms, a mouse control and scroll, a web page loading, selecting at least one link from said plurality of databases, a plurality of computer interaction habits of said at least one user, a plurality of user selection of color scheme, font, preferred types of text, music, image, and video-files, at least one rating of said at least one user composition, at least one comment, at least one collaboration habit and the like; a matching sub-module configured to match at least two users with at least one of a similar behavior, opposite values, experience, any specified parameters of habits, a plurality of preferences of said plurality of users and the like; and an artificial intelligence sub-module configured to mimic human behavior in playing against at least one computer means.

12. The system of claim 1, wherein said control module comprises a content control sub-module configured to retrieve at least one multimedia composition with an inappropriate content stored in said first database by said at least one user and control a plurality of multimedia compositions constituting plagiarism, by executing a set of instructions to remove and/or modify said at least one multimedia composition stored in said first database, wherein said inappropriate content comprise a derogatory language, a hatred language and any other inappropriate language; a user behavior control sub-module configured to identify at least one negative comment, said at least one multimedia composition constituting at least one of cyber bulling, an unauthorized use of an original material, a proprietary idea, any other proprietary intellectual property stored in said first database and said second database, executing a set of instructions to remove said at least one negative comment and said at least one multimedia composition from said plurality of databases, executing a set of instructions to formulate at least one adjustment to at least one user's score, and generate information about at least one unfair and inappropriate action of said at least one user; a reference control sub-module configured to generate a behavior information about said at least one of said user and organization exhibiting positive behavior or negative behavior on said interface of said at least one client device and executing a set of instructions to rate nominees based on feedback received from said plurality of users and store in said at least one database of said plurality of databases; and a parental control sub-module configured to provide means for parents to receive at least one information about their child's rating, grades, financial rewards and the like retrieved from said plurality of databases.

13. The system of claim 1, wherein said conflict resolution module comprises:
a submission sub-module configured to store a plurality of forms or information of said plurality of forms to a conflict resolution center database; and
a resolution processing sub-module configured to generate analysis of said plurality of forms stored in said conflict resolution center database, by retrieving a plurality of opinions, voting and rating of said plurality of users from at least one database of said plurality of databases, and generate at least one conflict resolution solution to said at least one user via said interface.

14. The system of claim 1, wherein said system further comprises an optimization module configured to engage a plurality of senior users in a plurality of cognitive exercise by providing a plurality of resources, engage said plurality of senior users in learning ancestry, engage a plurality of corporate users in learning a plurality of skills by providing a plurality of corporate resources for creating said plurality of multimedia compositions on said plurality of subjects, engage a plurality of young users in learning at least one of fields comprising reading, arts, music, and the like and collaborate with a plurality of family members, a plurality of peers, and a plurality of caregivers,
wherein said plurality of resources comprises a music therapy, an art therapy, a poetry therapy, a dance therapy, and any other expressive therapies and collaborate with said plurality of family members, said plurality of peers, and said plurality of caregivers, and said plurality of skills comprising a safety skill, an innovation skill, a plurality of language skills, and a plurality of professional skills and said system is further configured to execute a set of instructions to determine said at least one user with at least one of similar interest, preference, experience, with a plurality of desirable set of personality traits, social status, ethnic background, or any other desirable personal characteristics.

15. A method for multimedia based educational game learning for a plurality of users, comprising the steps of:
creating a plurality of multimedia compositions by at least one user, and executing a set of instructions to combine at least one link selected from a text, an image, an audio, and a video based link to said plurality of multimedia compositions;
retrieving said at least one user information from a plurality of databases;
tracking progress of said plurality of users, and managing a plurality of user groups and a plurality of user domains and facilitating a user collaboration on at least one level;
conducting at least one competition for a best multimedia composition and determining at least one partner and at least one sponsor for said at least one competition;
facilitating at least one rating by said plurality of users of an entire composition, and at least one of component and sub-components of said multimedia composition, wherein said at least one of components and sub-components comprise at least one part of text, image, audio, and video-files according to a plurality of criteria parameters;
executing a set of instructions to rate a plurality of comments of said plurality of users and a plurality of juries, wherein said plurality of criteria parameters comprise content and presentation form, and grading by a plurality of instructors;
providing said plurality of users as a reward at least one of a part of advertising, a plurality of sponsor links, a plurality of licensing revenues, and a plurality of competition prizes;
providing said plurality of users with a plurality of commerce capabilities and means for forming at least one of cooperatives, franchises, and means for evaluating and paying tax;
combining at least one of a plurality of entertainment and educational games, a plurality of physical games, a plurality of role playing games (RPG) and a plurality of RPG Forum games;
providing at least one of a customized content and a form according to at least one author preferences and at least one user preferences;
processing at least one of a digital image, an audio, a video, and a plurality of text files to achieve at least one desirable effect;
analyzing user behavior based on user-computer interaction and a plurality of user preferences;
determining said plurality of users with a desirable set of personality trait parameters, and to simulate human behavior;
processing a plurality of online forms with a plurality of user comments and complains;
analyzing at least one user's behavior based on a plurality of user's input means, said plurality of user's input means comprising a user's input to a plurality of forms, a mouse control and scroll, and a web page loading;
selecting at least one link from said plurality of databases, a plurality of computer interaction habits of said at least one user, a plurality of user selection of color scheme, font, preferred types of text, music, image, and video-files, at least one rating of said at least one user composition, at least one comment, at least one collaboration habit and the like;
matching at least two users with at least one of a similar behavior, opposite values, experience, any specified parameters of habits, a plurality of preferences of said plurality of users and the like; and
mimicking human behavior in playing against at least one computer means.

16. The method of claim 15, wherein said method further comprising the steps of:
providing means for displaying a plurality of user created compositions in public or private password protected galleries and sub-galleries hierarchically arranged for a plurality of topics within at least one gallery related to a same field or subject;
executing a set of instructions to perform at least one of a keyword searching, filtering said at least one multimedia composition on at least one of a subject and a topic;
determining at least one mentor and at least one consultant for at least one individual user and/or at least one team;
determining a plurality of user friends ready to offer help by retrieving information about said plurality of user friends from said plurality of databases;
retrieving at least one data from said plurality of databases, wherein said plurality of databases comprise at least one of text, image, audio, video-files, a plurality of links to a plurality of online resources, a plurality of tutorials on creation of online multimedia compositions, and a plurality of teaching courses for a plurality of fields and a plurality of topics comprising a teaching data and a testing data;
interacting with said plurality of friends by using at least one interaction platform and managing said plurality of user groups;
providing at least one user authentication, and executing a set of instructions to create a plurality of user accounts;
tracking an individual user progress for said plurality of users from at least one common organization according to a plurality of parameters, said plurality of parameters comprising a class, a grade, an organization department, a plurality of users names, rating of said plurality of multimedia compositions, grading by a plurality of teachers, a plurality of links to said plurality of multimedia compositions, a plurality of comments, and the like;
dividing a group or organizational users in a plurality of teams by executing a plurality of algorithms, executing at least one a set of instructions to provide at least one of a random selection, a specified group size, an alphabetical order of a plurality of user names, and the like;
providing means to said user to invite at least one other user on a team and manage said team;
tracking team user progress according to a plurality of parameters, said plurality of parameters comprising a class, a grade, an organization department, a plurality of user team names, combined score of individual team members, rating of said plurality of multimedia compositions, grading by a plurality of teachers, a plurality of links to said plurality of multimedia compositions, a plurality of comments, and the like;
enabling a plurality of authorized users to create, modify or remove at least one sub-domain within at least one authorized user domain wherein, said at least one sub-domain comprises at least one of a plurality of galleries for a plurality of subjects, at least one gallery for at least one topic and a project, a plurality of family galleries with at least one information resource, and a plurality of showcase multimedia compositions;
retrieving at least one multimedia composition with an inappropriate content stored in said first database by said at least one user and control a plurality of multimedia compositions constituting plagiarism, by executing a set of instructions to remove and/or modify said at least one multimedia composition stored in said first database, wherein said inappropriate content comprise a derogatory language, a hatred language and any other inappropriate language;
identifying at least one negative comment, said at least one multimedia composition constituting at least one of cyber bulling, an unauthorized use of an original material, a proprietary idea, any other proprietary intellectual property stored in said first database and said second database, executing a set of instructions to remove said at least one negative comment and said at least one multimedia composition from said plurality of databases, executing a set of instructions to formulate at least one adjustment to at least one user's score, and generate information about at least one unfair and inappropriate action of said at least one user;
generating a behavior information about said at least one of said user and organization exhibiting positive behavior or negative behavior on said interface of said at least one client device and executing a set of instructions to rate nominees based on feedback received from said plurality of users and store in said at least one database of said plurality of databases; and
providing means for parents to receive at least one information about their child's rating, grades, financial rewards and the like retrieved from said plurality of databases.

17. The method of claim 15, wherein said method further comprising the steps of:
conducting a plurality of online competitions for selecting a best multimedia composition, create a plurality of rubrics and specify a plurality of judging criteria, inviting a plurality of judges to enter a score;
determining a plurality of sponsors providing prizes in at least one form of monetary, product, a plurality of discount coupons, scholarship, and a plurality of rewards, and add sponsor links to said user created compositions;
determining a plurality of partners and challenge at least one competitor team;
determining a plurality of mentors and a plurality of consultants providing expert opinion and help with creating said plurality of multimedia compositions;
executing a set of instructions to share said at least one multimedia composition information in a real time and create at least one new multimedia composition by said at least one user;
contacting said plurality of users based on at least one share parameter to rate at least one of said plurality of user's original multimedia compositions, and a plurality of users modified multimedia compositions proposed by said plurality of users in real time;
retrieving information about said plurality of users determined as at least one friend from said user database and said at least one share parameter comprises said plurality of users sharing at least one topic of interest and the like;
enabling a plurality of user interactions through chat, bulletin boards, and the like;
providing at least one of a plurality of entertaining games and a plurality of links to said plurality of entertaining games, retrieved from a physical game database, said physical game database comprising at least one of a physical game, a football game, a baseball game, a soccer game, and the like;
providing means for building a virtual environment or customizing a user's gallery according to said plurality of user's preferences;
providing means for generating a plurality of virtual characters, and executing a set of instructions to provide means to retrieve at least one RPG character from said avatar database, weapons, tools, and other gaming items, character traits, power, and the like;
providing means to keep track of said plurality of user created multimedia compositions, rating of said user created multimedia compositions, a plurality of views and said user's progress through a plurality of ranks according to a specified algorithm considering said rating and said plurality of views of user created multimedia compositions and community service points received for posting links of non-profit organizations, reporting at least one inappropriate content, and performing other community useful actions;
providing means for creating at least guild, a plurality of professional societies and the like;
providing means for developing a common thread and a plurality of alternative threads by incorporating at least one of said plurality of images, said plurality of sound, said plurality of video-files, a plurality of related real life events, a plurality of fictional action events, and means to incorporate said plurality of scenarios, a plurality of templates comprising at least one template for developing a thread from at least one of a first person perspective, a second person perspective, and a third-person perspective, and a plurality of RPG Forum based format comprising at least one story written by said at least one user;
providing means for rating at least one of a plurality of virtual characters and a plurality of real characters, means to incorporate said plurality of comments from said plurality of users and means for assigning score to said plurality of users based on a plurality of human behavior trait parameters, said plurality of human behavior traits comprise a honesty trait, an intellect trait, a readiness to help trait and the like;
providing a plurality of virtual galleries for exhibiting user created multimedia compositions related to said RPG and RPG Forum games comprising everyday life games, a plurality of invention games, a plurality of business games, a plurality of masquerade games, a plurality of fantasy sport-like games, a plurality of fair players gallery, a plurality of unfair players gallery and the like;
providing means for developing at least one new game by said at least one user, said plurality of RPG and RPG Forum based games comprising a plurality of virtual reality games, a plurality of real reality games, a plurality of everyday life games, said plurality of invention games, said plurality of business games, said plurality of masquerade games, said plurality of fantasy sport-like games, and the like; and
managing a blog information of at least one of a plurality of real societies, a plurality of virtual societies, a plurality of guilds and a plurality of organizations.

18. The method of claim 15, wherein said method further comprising the steps of:
creating a plurality of advertisements and a plurality of sponsor banners, combining a plurality of media, storing at least one of a plurality of existing advertisements and a plurality of sponsor banners in at least one link database comprising a plurality of advertisement links and a plurality of sponsor banners;
adding said plurality of advertisement links and/or said plurality of sponsor links to said at least one link database determined by at least one users' rank and membership level;
accessing said at least one link database determined by said users' rank and membership level;
selecting said plurality of advertisement links retrieved from said at least one link database determined by said users' rank and membership level;
providing at least one link selected from said plurality of advertisement links and/or said plurality of sponsor links on said interface of said at least one client device along with said user's multimedia composition in a user defined location and a user defined format with a preference of said user defined location and user defined format determined by said users' rank and membership level;
evaluating corresponding reward made to said plurality of users in a form of at least one reward according to at least one of a specified algorithm and a plurality of second reward parameters and rating of said plurality of multimedia compositions;
providing license to at least one user of at least one user's original text, audio, image, video-file and/or multimedia composition stored in said resource database for a specified payment gateway with a licensing fees determined by at least one of a fixed price, a percent of total revenues generated through said plurality of advertising links and said plurality of sponsor links posted along with said multimedia composition utilizing said original material;
providing means for said at least one user and a plurality of viewers to customize at least one authoring tool for viewing environment, wherein said at least one authoring tool is selected from a background tool, a layout tool, a text font tool, and the like according to said plurality of user preferences;
providing means for said at least one user to select and customize a plurality of text, image, sound, and video-files according to said plurality of user preferences by retrieving information from a resource database;
providing means for at least one of an image enhancement, manipulation, distortion, and any other operations with said plurality of images, providing means for at least one of a sound enhancement, manipulation, distortion, and any other operations with a plurality of sounds;
providing means for at least one of a video-file enhancement, manipulation, distortion, and any other operations with a plurality of video-files, providing means for manipulation, distortion, and other operations with a plurality of text files;
combining at least one of said plurality of image files, said plurality of sound files, said plurality of video files and said plurality of text files in layers, providing means for writing between a plurality of lines, hiding text, said plurality of image files, said plurality of sound files, and said plurality of video files and activate at least one of control between said plurality of lines, behind said plurality of text files, and said plurality of image files and said means for processing comprise modification, combination, manipulation of said at least one of said plurality of image files, said plurality of sound files, said plurality of video files and said plurality of text files and spell-check and grammar analysis of said plurality of text files;
storing a plurality of forms or information of said plurality of forms in a conflict resolution center database; and
generating analysis of said plurality of forms stored in said conflict resolution center database, by retrieving a plurality of opinions, voting and rating of said plurality of users from at least one database of said plurality of databases, and generate at least one conflict resolution solution to said at least one user via said interface.

19. The method of claim 15, wherein conducting a plurality of transactions on an interface of at least one client device comprising the steps of:
enabling said plurality of users to sell a plurality of products or buy said plurality of products, conducting a plurality of transactions over said communication network where said plurality of products that said at least one user post for sell depends on said user's gaming score and type of membership;
forming a plurality of cooperatives comprising at least one of a plurality of creative cooperatives, a plurality of consulting cooperatives, a plurality of educational cooperatives and the like, said plurality of creative cooperatives comprising at least one of a plurality of cooperatives producing art, music, literature and the like, said plurality of consulting cooperatives comprising at least one of a plurality of cooperatives providing technical consulting services for technical design, solution of technical problems, any other type of technical services and the like and said plurality of educational cooperatives comprising at least one of a plurality of cooperatives providing tutoring services in a plurality of fields comprising science, art, physical fitness, professional skills and the like;
providing means to create, manage, and conduct at least one transaction in a plurality of user formed franchises, said plurality of user formed franchises comprise a plurality of educational franchises, a plurality of creative franchises and the like; and
providing means for generating a plurality of online user accounts, managing said plurality of online user accounts, maintaining said plurality of user's personal information, conducting at least one transaction to pay for a membership fee, evaluating tax and providing tax related information to said plurality of users and transferring funds in and from said plurality of online user accounts.

20. The method of claim 15, wherein said method further comprising the steps of:
engaging a plurality of senior users in a plurality of cognitive exercise by providing a plurality of resources and engaging said plurality of senior users in learning ancestry;
engaging a plurality of corporate users in learning a plurality of skills by providing a plurality of corporate resources for creating said plurality of multimedia compositions on said plurality of subjects and collaborate said plurality of corporate users with a plurality of family members, a plurality of peers, and a plurality of caregivers;
engaging a plurality of young users in learning at least one of fields comprising reading, arts, music, and the like and collaborate with said plurality of family members, said plurality of peers, and said plurality of caregivers;
determining at least two users with at least one of similar interest, a preference, an experience, a plurality of desirable personality traits, a social status, an ethnic background, or any other desirable personal characteristic;
wherein said plurality of corporate resources comprise at least one therapy selected from a music therapy, an art therapy, a poetry therapy, a dance therapy, and any other expressive therapies and said plurality of skills comprising a safety skill, an innovation skill, a plurality of language skills, and a plurality of professional skills.

21. The method of claim 15, wherein said at least one level comprising an individual level and a team level, said at least one interaction platform comprising a chat, a discussion forum, any other type of user interaction platform, and said plurality of second reward parameters comprise advertising, a plurality of sponsor links, number of views and composition rating, a plurality of licensing fees, and community service including, but not limited to reporting multimedia compositions with an inappropriate content, a plurality of posted links of non-profit organizations or their donors and sponsors, and a plurality of multimedia compositions promoting social cause and said at least one reward comprising a monetary reward, a non-monetary reward, a scholarship, a plurality of bonds, a plurality of product discounts and the like.
